(19) United States
(12) Patent Application Publication
(10) Pub. No.: US 2025/0334718 A1
(43) Pub. Date: Oct. 30, 2025

(54) SURFACE MODIFIED SILICONE OPHTHALMIC DEVICE

(71) Applicant: Bausch + Lomb Ireland Limited, Dublin (IE)

(72) Inventor: Yongxing Qiu, Rochester, NY (US)

(21) Appl. No.: 19/092,268

(22) Filed: Mar. 27, 2025

Related U.S. Application Data
(60) Provisional application No. 63/640,361, filed on Apr. 30, 2024.

(51) Int. Cl. G02B 1/04; G02C 7/04

(52) U.S. Cl. CPC G02B 1/043; G02C 7/049

(57) ABSTRACT

A surface modified silicone ophthalmic device includes a silicone ophthalmic device which is a polymerization product of a silicone ophthalmic device-forming monomeric mixture containing (a) one or more hydrophilic monomers, (b) one or more monofunctional silicone monomers represented by a structure of Formula I:

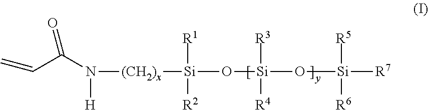

wherein R¹, R², R³, R⁴, R⁵, R⁶, R⁷, x and y are as defined herein, (c) one or more anionic ophthalmic device forming monomers, and (d) one or more crosslinking agents, and a surface coating on the silicone ophthalmic device, the surface coating including a cationic copolymer including (i) monomeric units derived from a cationic monomer having an ethylenically unsaturated reactive end group, and (ii) monomeric units derived from a hydrophilic monomer having an ethylenically unsaturated reactive group.

### PRIORITY CLAIM

The present application claims priority to U.S. Provisional Patent Application Ser. No. 63/640,361, entitled “Surface Modified Silicone Ophthalmic Device,” filed Apr. 30, 2024, the content of which is incorporated by reference herein in its entirety.

### BACKGROUND

Ophthalmic devices such as contact lenses made from, for example, silicone-containing materials, have been investigated for a number of years. Such materials can generally be subdivided into two major classes, namely hydrogels and non-hydrogels. Hydrogels can absorb and retain water in an equilibrium state, whereas non-hydrogels do not absorb appreciable amounts of water. Regardless of their water content, both hydrogel and non-hydrogel silicone medical devices tend to have relatively hydrophobic, non-wettable surfaces that have a high affinity for lipids. This problem is of particular concern with contact lenses.

Those skilled in the art have long recognized the need for modifying the surface of a surface modified silicone ophthalmic devices such as silicone contact lenses so that they are compatible with the eye. For example, by increasing the hydrophilicity of a contact lens surface, the wettability of the contact lens can be improved. This, in turn, is associated with improved wear comfort of the contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

### SUMMARY

In accordance with an illustrative embodiment, a surface modified silicone ophthalmic device comprises:
a silicone ophthalmic device which is a polymerization product of a silicone ophthalmic device-forming monomeric mixture comprising:
(a) one or more hydrophilic monomers,
(b) one or more monofunctional silicone monomers represented by a structure of Formula I:

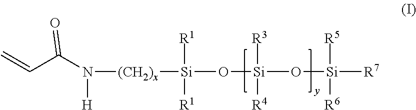

wherein R¹, R², R³, R⁴, R⁵, R⁶, R⁷, x and y are as defined herein,
(c) one or more anionic ophthalmic device forming monomers, and
(d) one or more crosslinking agents, and
a surface coating on the silicone ophthalmic device, the surface coating comprising a cationic copolymer comprising (i) monomeric units derived from a cationic monomer having an ethylenically unsaturated reactive end group, and (ii) monomeric units derived from a hydrophilic monomer having an ethylenically unsaturated reactive group.

In accordance with another illustrative embodiment, a method for making a surface modified silicone ophthalmic device comprises:
providing a silicone ophthalmic device which is a polymerization product of a silicone ophthalmic device-forming monomeric mixture comprising:
(a) one or more hydrophilic monomers,
(b) one or more monofunctional silicone monomers represented by a structure of Formula I:

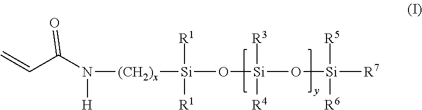

wherein R¹, R², R³, R⁴, R⁵, R⁶, R⁷, x and y are as defined herein,
(c) one or more anionic ophthalmic device forming monomers, and
(d) one or more crosslinking agents, and
exposing the silicone ophthalmic device to a cationic copolymer comprising (i) monomeric units derived from a cationic monomer having an ethylenically unsaturated reactive end group, and (ii) monomeric units derived from a hydrophilic monomer having an ethylenically unsaturated reactive group, thereby forming a surface coating on the silicone ophthalmic device.

In accordance with yet another illustrative embodiment, a packaging system for the storage of a surface modified silicone ophthalmic device comprises a sealed container containing an unused silicone ophthalmic device immersed in an aqueous packaging solution comprising a cationic copolymer comprising (i) monomeric units derived from a cationic monomer having an ethylenically unsaturated reactive end group, and (ii) monomeric units derived from a hydrophilic monomer having an ethylenically unsaturated reactive group, wherein the unused silicone ophthalmic device is a polymerization product of a silicone ophthalmic device-forming monomeric mixture comprising:
(a) one or more hydrophilic monomers,
(b) one or more monofunctional silicone monomers represented by a structure of Formula I:

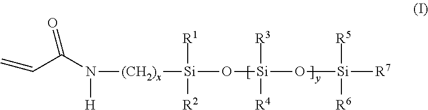

wherein R¹, R², R³, R⁴, R⁵, R⁶, R⁷, x and y are as defined herein,
(c) one or more anionic ophthalmic device forming monomers, and
(d) one or more crosslinking agents, and
wherein the aqueous packaging solution has an osmolality of at least about 150 mOsm/kg, a pH of about 6 to about 9 and is sterilized.

In accordance with still yet another illustrative embodiment, a method of preparing a packaging system comprising a storable, sterile surface modified silicone ophthalmic device comprises:
(a) providing an unused silicone ophthalmic device, wherein the unused silicone ophthalmic device is a polymerization product of a silicone ophthalmic device-forming monomeric mixture comprising.
(i) one or more hydrophilic monomers,
(ii) one or more monofunctional silicone monomers represented by a structure of Formula I:

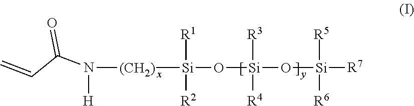

wherein R¹, R², R³, R⁴, R⁵, R⁶, R⁷, x and y are as defined herein,
(iii) one or more anionic ophthalmic device forming monomers, and
(iv) one or more crosslinking agents,
(b) immersing the unused silicone ophthalmic device in an aqueous packaging solution comprising a cationic copolymer comprising (i) monomeric units derived from a cationic monomer having an ethylenically unsaturated reactive end group, and (ii) monomeric units derived from a hydrophilic monomer having an ethylenically unsaturated reactive group, wherein the aqueous packaging solution has an osmolality of at least about 150 mOsm/kg and a pH in the range of about 6 to about 9,
(c) packaging the aqueous packaging solution and the unused silicone ophthalmic device in a manner preventing contamination of the ophthalmic device by microorganisms, and
(d) sterilizing the packaged solution and unused silicone ophthalmic device.

### DETAILED DESCRIPTION

Various illustrative embodiments described herein are directed to surface modified silicone ophthalmic devices such as silicone contact lenses having a surface coating derived from a cationic copolymer.

One approach to modifying the hydrophilicity and wettability of a silicone ophthalmic device is the incorporation of wetting agents (hydrophilic polymers) into a lens formulation for making a silicone hydrogel contact lens. However, problems associated with this technique include that, for example, the wetting agents may impart haziness to the resulting lenses because of their incompatibility with other silicone components in the lens formulation and may not provide a durable hydrophilic surface for extended wear purposes.

Another approach involves the extraction of the silicone ophthalmic device with an organic solvent, contacting the extracted silicone ophthalmic device with an organic solvent-based coating solution to form a stable, interpenetrating base coating on the silicone ophthalmic device, rinsing of the silicone ophthalmic device with a mixture of water and an organic solvent, and covalently attaching a partially-crosslinked hydrophilic polymeric material onto the base coating directly in a package during autoclaving. However, the use of an organic solvent extraction step is not environmentally friendly.

The non-limiting illustrative embodiments disclosed herein overcome the foregoing drawbacks by providing a water extractable surface modified silicone ophthalmic device comprising a silicone ophthalmic device which is a polymerization product of a silicone ophthalmic device-forming monomeric mixture comprising:
(a) one or more hydrophilic monomers,
(b) one or more monofunctional silicone monomers represented by a structure of Formula I:

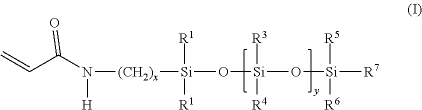

wherein R¹, R², R³, R⁴, R⁵, R⁶, R⁷, x and y are as defined herein,
(c) one or more anionic ophthalmic device forming monomers, and
(d) one or more crosslinking agents, and
a surface coating on the silicone ophthalmic device, the surface coating comprising a cationic copolymer comprising (i) monomeric units derived from a cationic monomer having an ethylenically unsaturated reactive end group, and (ii) monomeric units derived from a hydrophilic monomer having an ethylenically unsaturated reactive group.

The surface modified silicone ophthalmic device according to the non-limiting illustrative embodiments described herein advantageously form a water extracted, surface modified silicone ophthalmic device such as a silicone hydrogel (SiHy) lens using a silicone ophthalmic device forming formulation that allows for water extraction instead of an organic solvent extraction. In addition, the water extracted, surface modified silicone ophthalmic device according to the non-limiting illustrative embodiments described herein exhibits relatively high surface wettability via a cationic copolymer wetting agent as either a packaging wetting agent additive or as a wetting agent additive during water extraction.

As used herein, the term “SiHy” shall be understood to mean silicone hydrogel.

As used herein, the term “hydrogel” or “hydrogel material” refers to a crosslinked polymeric material that has three-dimensional polymer networks (i.e., polymer matrix), is insoluble in water, but can hold at least 10 percent by weight of water in its polymer matrix when it is fully hydrated.

As used herein, the term “silicone hydrogel” or “SiHy” interchangeably refers to a hydrogel containing silicone. A silicone hydrogel (SiHy) typically is obtained by copolymerization of a polymerizable composition comprising at least one silicone-containing vinylic monomer or at least one silicone-containing vinylic macromer or at least one silicone-containing prepolymer having ethylenically unsaturated groups.

As used herein, the term “(meth)” denotes an optional methyl substituent. Thus, terms such as “(meth)acrylate” denotes either methacrylate or acrylate, and “(meth)acrylamide” denotes either methacrylamide or acrylamide.

As used herein, the term “ophthalmic device” refers to ophthalmic devices that reside in or on the eye. These devices can provide optical correction, wound care, drug delivery, diagnostic functionality or cosmetic enhancement or effect or a combination of these properties. Suitable ophthalmic devices include, for example, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking. A contact lens can be in a dry state or a wet state. A “dry state” refers to a soft contact lens in a state prior to hydration or the state of a hard lens under storage or use conditions. A “wet state” refers to a soft contact lens in a hydrated state.

In accordance with non-limiting illustrative embodiments, a silicone ophthalmic device-forming monomeric mixture for forming the surface modified silicone ophthalmic device described herein includes one or more hydrophilic monomers. Suitable one or more hydrophilic monomers include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof.

Representative examples of unsaturated carboxylic acids include, but are not limited to, methacrylic acid, acrylic acid and the like and mixtures thereof. Representative examples of acrylamides include, but are not limited to, alkylacrylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), glycerol methacrylate and the like and mixtures thereof. Additional device-forming hydrophilic comonomers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. Mixtures of the foregoing hydrophilic monomers can also be used in the silicone ophthalmic device-forming monomeric mixtures herein.

In accordance with one or more non-limiting illustrative embodiments, as may be combined with one or more of the preceding paragraphs, the one or more hydrophilic monomers can be present in the silicone ophthalmic device-forming monomeric mixture in an amount ranging from about 5 wt. % to about 60 wt. %, based on the total weight of the silicone ophthalmic device-forming monomeric mixture. In another illustrative embodiment, the one or more hydrophilic monomers can be present in the silicone ophthalmic device-forming monomeric mixture in an amount ranging from about 10 wt. % to about 50 wt. %, based on the total weight of the silicone ophthalmic device-forming monomeric mixture.

In accordance with one or more non-limiting illustrative embodiments, as may be combined with one or more of the preceding paragraphs, a silicone ophthalmic device-forming monomeric mixture for forming the surface modified silicone ophthalmic device described herein further includes one or more monofunctional silicone monomers represented by a structure of Formula I:

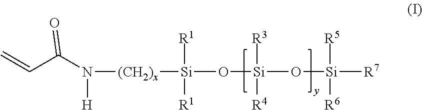

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15.

In one embodiment, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In one embodiment, R¹, R², R³ and R⁴ are independently hydrogen or a C₁ to C₆ alkyl group; R⁵, R⁶ and R⁷ are independently a straight or branched C₁ to C₆ alkyl group; x is from 1 to 6; and y is from 3 to 8.

In one embodiment, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 8.

In some embodiments, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

Representative examples of alkyl groups for use herein include, by way of example, a straight or branched alkyl chain radical containing carbon and hydrogen atoms of from 1 to about 30 carbon atoms or from 1 to about 12 carbon atoms or from 1 to about 6 carbon atoms with or without unsaturation, to the rest of the molecule, e.g., methyl, ethyl, n-propyl, 1-methylethyl (isopropyl), n-butyl, n-pentyl, methylene, ethylene, etc., and the like, optionally containing one or more heteroatoms, e.g., O and N, and the like, or one or more halogen atoms, e.g., fluorine, chlorine, bromine, and iodine, to form a halo alkyl group.

Representative examples of cycloalkyl groups for use herein include, by way of example, a substituted or unsubstituted, non-aromatic mono or multicyclic ring system of about 3 to about 30 carbon atoms or from 3 to about 12 carbon atoms or from 3 to about 6 carbon atoms such as, for example, cyclopropyl, cyclobutyl, cyclopentyl, cyclohexyl, perhydronapththyl, adamantyl and norbornyl groups, bridged cyclic groups or sprirobicyclic groups, e.g., spiro-(4, 4)-non-2-yl and the like, optionally containing one or more heteroatoms, e.g., O and N, and the like to form a heterocycloalkyl group.

Representative examples of cycloalkylalkyl groups for use herein include, by way of example, a substituted or unsubstituted, cyclic ring-containing radical containing from about 4 to about 30 carbon atoms or from 3 to about 6 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like to form a heterocycloalkylalkyl group.

Representative examples of cycloalkenyl groups for use herein include, by way of example, a substituted or unsubstituted cyclic ring-containing radical containing from about 3 to about 30 carbon atoms or from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like to form a heterocycloalkenyl group.

Representative examples of aryl groups for use herein include, by way of example, a substituted or unsubstituted, monoaromatic or polyaromatic radical containing from about 6 to about 30 carbon atoms or from about 6 to about 12 carbon atoms such as, for example, phenyl, naphthyl, tetrahydronapthyl, indenyl, biphenyl and the like, optionally containing one or more heteroatoms, e.g., O and N, and the like to form a heteroaryl group.

In some embodiments, a silicone ophthalmic device-forming monomeric mixture for forming the surface modified silicone ophthalmic device described herein will include a first monofunctional silicone monomer and a second monofunctional silicone monomer each represented by a structure of Formula I. For example, in one non-limiting illustrative embodiment a first monofunctional silicone monomer represented by a structure of Formula I includes where R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5, and a second monofunctional silicone monomer represented by a structure of Formula I includes where R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 7 to 15.

In an illustrative embodiment, the monofunctional silicone monomer represented by the structure of Formula I is either commercially available from such sources as ShinEtsu or can be made by methods within the purview of one skilled in the art. For example, in an illustrative embodiment, the monofunctional silicone monomer represented by the structure of Formula I can be prepared according to the following reaction Scheme I.

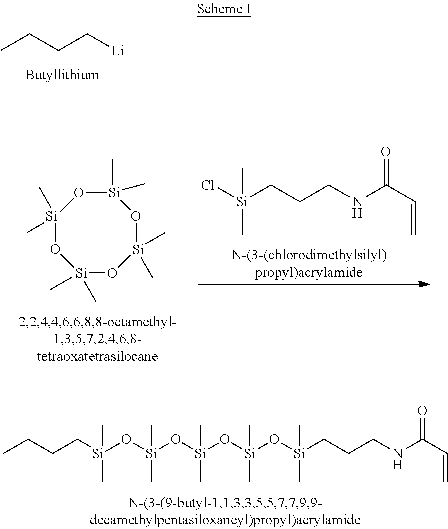

In accordance with one or more non-limiting illustrative embodiments, as may be combined with one or more of the preceding paragraphs, the monofunctional silicone monomer represented by a structure of Formula I can be present in the silicone ophthalmic device-forming monomeric mixture in an amount ranging from about 10 wt. % to about 55 wt. %, based on the total weight of the silicone ophthalmic device-forming monomeric mixture. In another illustrative embodiment, the monofunctional silicone monomer represented by a structure of Formula I can be present in the silicone ophthalmic device-forming monomeric mixture in an amount ranging from about 10 wt. % to about 45 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further contains one or more anionic (having a negative charge) ophthalmic device forming monomers. Suitable one or more anionic ophthalmic device forming monomers include, for example, acrylic acid, methacrylic acid (i.e., C₄H₅O₂—), itaconic acid, or a vinyl acid such as N-[ethyloxy)carbonyl]-β-alanine. In some embodiments, the one or more anionic (having a negative charge) ophthalmic device forming monomers are one or more anionic-forming monomers.

In accordance with one or more non-limiting illustrative embodiments, as may be combined with one or more of the preceding paragraphs, the one or more anionic ophthalmic device forming monomers can be present in the silicone ophthalmic device-forming monomeric mixture in an amount ranging from about 1 wt. % to about 10 wt. %, based on the total weight of the silicone ophthalmic device-forming monomeric mixture. In another illustrative embodiment, the one or more anionic ophthalmic device forming monomers can be present in the silicone ophthalmic device-forming monomeric mixture in an amount ranging from about 1 wt. % to about 5 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further contains one or more crosslinking agents. Suitable crosslinking agents for use herein are known in the art. For example, in non-limiting illustrative embodiments, suitable one or more cross-linking agents include one or more crosslinking agents containing at least two ethylenically unsaturated reactive end groups. In one embodiment, the ethylenically unsaturated reactive end groups are (meth)acrylate-containing reactive end groups. In another embodiment, the ethylenically unsaturated reactive end groups are non-(meth)acrylate reactive end groups. In one embodiment, the ethylenically unsaturated reactive end groups are a combination of one or more (meth)acrylate-containing reactive end groups and one or more non-(meth)acrylate reactive end groups.

In an illustrative embodiment, useful one or more crosslinking agents containing at least two ethylenically unsaturated reactive end groups include, for example, one or more di-, tri- or tetra(meth)acrylate-containing crosslinking agents. In an illustrative embodiment, useful one or more di-, tri- or tetra(meth)acrylate-containing crosslinking agents include, for example, alkanepolyol di-, tri- or tetra(meth)acrylate-containing crosslinking agents such as, for example, one or more alkylene glycol di(meth)acrylate crosslinking agents, one or more alkylene glycol tri(meth)acrylate crosslinking agents, one or more alkylene glycol tetra(meth)acrylate crosslinking agents, one or more alkanediol di(meth)acrylate crosslinking agents, alkanediol tri(meth)acrylate crosslinking agents, alkanediol tetra(meth)acrylate crosslinking agents, agents, one or more alkanetriol di(meth)acrylate crosslinking agents, alkanetriol tri(meth)acrylate crosslinking agents, alkanetriol tetra(meth)acrylate crosslinking agents, agents, one or more alkanetetraol di(meth)acrylate crosslinking agents, alkanetetraol tri(meth)acrylate crosslinking agents, alkanetetraol tetra(meth)acrylate crosslinking agents and the like and mixtures thereof.

In an illustrative embodiment, one or more alkylene glycol di(meth)acrylate crosslinking agents include tetraethylene glycol dimethacrylate, ethylene glycol di(meth)acrylates having up to about 10 ethylene glycol repeating units, butyleneglycol di(meth)acrylate and the like. In one embodiment, one or more alkanediol di(meth)acrylate crosslinking agents include butanediol di(meth)acrylate crosslinking agents, hexanediol di(meth)acrylate and the like. In one embodiment, one or more alkanetriol tri(meth)acrylate crosslinking agents are trimethylol propane trimethacrylate crosslinking agents. In one embodiment, one or more alkanetetraol tetra(meth)acrylate crosslinking agents are pentaerythritol tetramethacrylate crosslinking agents.

In a non-limiting illustrative embodiment, suitable crosslinking agents include, for example, ethylene glycol diacrylate, diethylene glycol diacrylate, allyl acrylate, 1,3-propanediol diacrylate, 2,3-propanediol diacrylate, 1,6-hexanediol diacrylate, 1,4-butanediol diacrylate, triethylene glycol diacrylate, cyclohexane-1,1-diyldimethanol diacrylate, 1,4-cyclohexanediol diacrylate, 1,3-adamantanediol diacrylate, 1,3-adamantanedimethyl diacrylate, 2,2-diethyl-1,3-propanediol diacrylate, 2,2-diisobutyl-1,3-propanediol diacrylate, 1,3-cyclohexanedimethyl diacrylate, 1,4-cyclohexanedimethyl diacrylate; neopentyl glycol diacrylate, tetraethyleneglycol diacrylate, polyethyleneglycol diacrylate; and their corresponding methacrylates.

In a non-limiting illustrative embodiment, suitable crosslinking agents include, for example, 1,4-butanediol diacrylate, 1,4-butanediol dimethacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, 1,3-propanediol diacrylate, 1,3-propanediol dimethacrylate, 1,6-hexanediol diacrylate, 1,6-hexanediol dimethacrylate, poly(ethylene glycol) diacrylate (Mn=700 Daltons), poly(ethylene glycol) dimethacrylate (Mn=700 Daltons), and poly(ethylene glycol) dimethacrylate (Mn=1000 Daltons).

In one embodiment, the one or more crosslinking agents containing at least two ethylenically unsaturated reactive end groups include at least one allyl-containing reactive end group and at least one (meth)acrylate-containing reactive end group. In an illustrative embodiment, the one or more crosslinking agents can be allyl methacrylate.

In non-limiting illustrative embodiments, as may be combined with one or more of the preceding paragraphs, the one or more crosslinking agents are present in the silicone ophthalmic device-forming monomeric mixture in an amount of about 0.1 wt. % to 10 wt. %, based on the total weight of the silicone ophthalmic device-forming monomeric mixture. In non-limiting illustrative embodiments, as may be combined with one or more of the preceding paragraphs, the one or more crosslinking agents are present in the silicone ophthalmic device-forming monomeric mixture in an amount of about 0.1 wt. % to about 5 wt. %, based on the total weight of the silicone ophthalmic device-forming monomeric mixture. In non-limiting illustrative embodiments, as may be combined with one or more of the preceding paragraphs, the one or more crosslinking agents are present in the silicone ophthalmic device-forming monomeric mixture in an amount of about 0.2 wt. % to about 10 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further contains one or more silicone ophthalmic device-forming silicone comonomers. In some embodiments, a class of representative silicone ophthalmic device-forming silicone comonomers includes one or more non-bulky organosilicon-containing monomers. An “organosilicon-containing monomer” as used herein contains at least one [siloxanyl] or at least one [silyl-alkyl-siloxanyl]repeating unit, in a monomer, macromer or prepolymer. In an illustrative embodiment, an example of a non-bulky organosilicon-containing monomers is represented by a structure of Formula IIa:

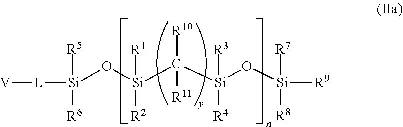

wherein V is an ethylenically unsaturated polymerizable group, L is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, 0-vinyl carbamates, N-vinyl carbamates, and (meth)acrylamides.

Linking groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In some embodiments, V is a (meth)acrylate, L is a C₁ to C₁₂ alkylene group, R¹, R², R³, R⁴, R⁵, R⁶, R⁷, R₈, and R⁹ are independently a C₁ to C₁₂ alkyl group, R¹⁰ and R¹¹ are independently H or a C₁ to C₁₂ alkyl group, y is 2 to 7 and n is 3 to 8.

In some embodiments, V is a (meth)acrylate, L is a C₁ to C₆ alkyl group, R¹, R², R³, R⁴, R⁵, R⁶, R⁷, R₈, and R⁹ are independently a C₁ to C₆ alkyl group, R¹⁰ and R¹¹ are independently H or a C₁ to C₆ alkyl group, y is 2 to 7 and n is 1 to 20.

Non-bulky organosilicon-containing monomers represented by a structure of Formula IIa are known in the art, see, e.g., U.S. Pat. Nos. 7,915,323, 7,994,356, 8,420,711, 8,827,447 and 9,039,174, the contents of which are incorporated by reference herein.

In an illustrative embodiment, as may be combined with one or more of the preceding paragraphs, the one or more non-bulky organosilicon-containing monomers can also include a compound represented by a structure of Formula IIb:

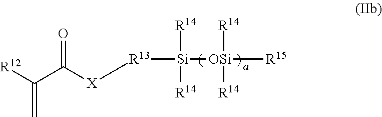

wherein R¹² is H or methyl; X is O or NR¹⁶; wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IIb are known in the art, see, e.g., U.S. Pat. Nos. 8,703,891, 8,937,110, 8,937,111, 9,156,934 and 9,244,197, the contents of which are incorporated by reference herein.

Representative examples of the non-bulky organosilicon-containing monomers include:
M1EDS6: a compound having the structure and available from Gelest:

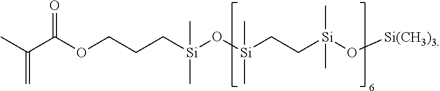

MCR-M11: a compound having the structure:

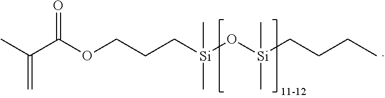

M1-MCR-C12: a compound having the structure:

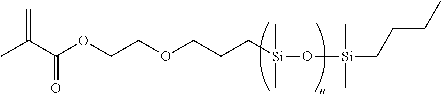

wherein n is an average of 12.

In an illustrative embodiment, as may be combined with one or more of the preceding paragraphs, the one or more silicone ophthalmic device-forming silicone comonomers can include, as a class of representative silicone ophthalmic device-forming silicone comonomers, one or more polysiloxane prepolymers represented by a structure of Formula III:

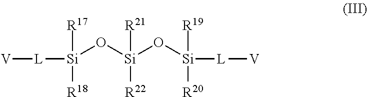

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

A hydroxyl-containing reactive functional end group for use herein is a group of the general Formula —OH. Representative examples of amine-containing reactive functional end groups for use herein include, by way of example, a (meth)acrylamide-containing reactive functional end group.

Linking group L is independently a straight or branched alkyl group, cycloalkyl group, an aryl group, an ether or polyether group, and an ester group as defined herein.

A representative example of a polysiloxane prepolymer is as follows:

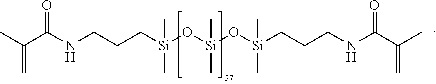

Methods for making the polysiloxane prepolymers described herein are well known and within the purview of one skilled in the art. In addition, the polysiloxane prepolymers are also commercially available from such sources as, for example, Gelest, Silar, Shin-Etsu, Momentive and Siltech.

In an illustrative embodiment, as may be combined with one or more of the preceding paragraphs, the one or more silicone ophthalmic device-forming silicone comonomers can include, as a class of representative silicone ophthalmic device-forming silicone comonomers, one or more monomers of Formulae IV and V:

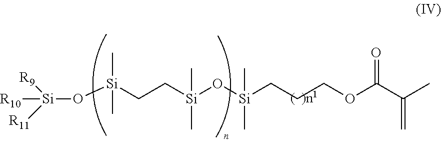

wherein R₉, R₁₀ and R₁₁ are independently hydrogen, an alkyl group, a haloalkyl group or other substituted alkyl groups; n is as defined above and n¹ is 0 to 10; and,

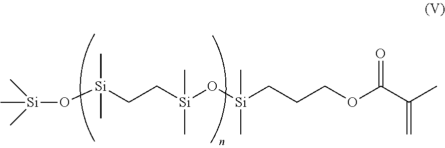

wherein n is 1 to 100, or n is 2 to 80, or n is 3 to 20, or n is 5 to 15.

In an illustrative embodiment, as may be combined with one or more of the preceding paragraphs, the one or more silicone ophthalmic device-forming silicone comonomers can include, as a class of representative silicone ophthalmic device-forming silicone comonomers, one or more monomers of Formulas VI-X:

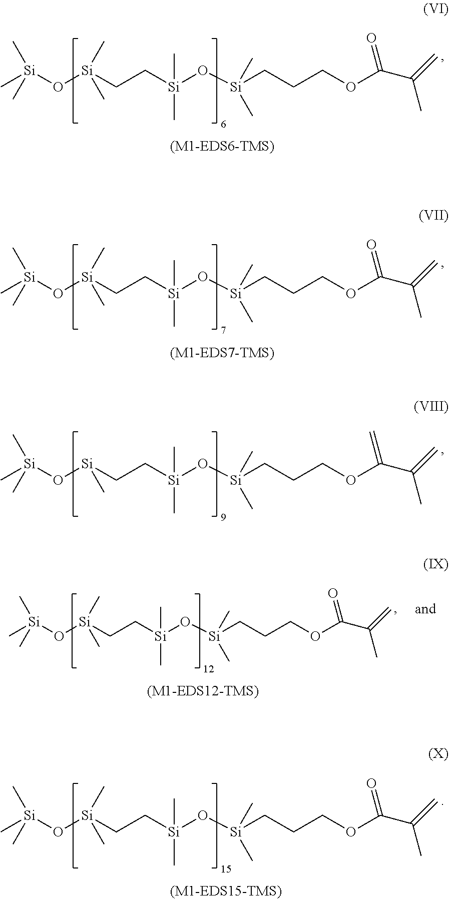

In an illustrative embodiment, as may be combined with one or more of the preceding paragraphs, the one or more silicone ophthalmic device-forming silicone comonomers can include, as a class of representative silicone ophthalmic device-forming silicone comonomers, one or more monomers of Formulas XI-XIII:

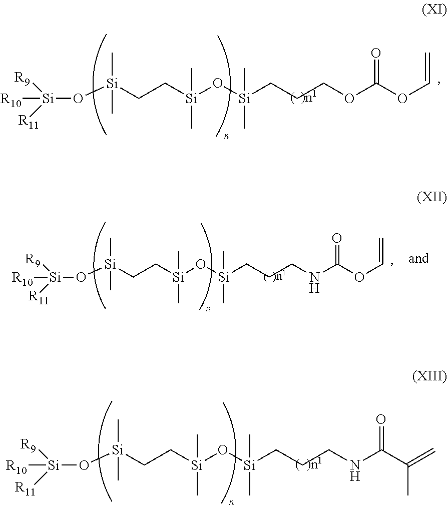

wherein R₉, R₁₀ and R₁₁ are independently hydrogen, an alkyl group, a haloalkyl group or other substituted alkyl groups and n and n¹ are as defined above.

In accordance with one or more additional non-limiting illustrative embodiments, as may be combined with one or more of the preceding paragraphs, the one or more silicone ophthalmic device-forming silicone comonomers can be present in the silicone ophthalmic device-forming monomeric mixture in an amount ranging from about 5 wt. % and to 20 wt. %, based on the total weight of the silicone ophthalmic device-forming monomeric mixture.

In accordance with one or more additional non-limiting illustrative embodiments, as may be combined with one or more of the preceding paragraphs, the silicone ophthalmic device-forming monomeric mixture can further contain one or more ultraviolet (UV) light blockers having an ethylenically unsaturated reactive group. Suitable UV light blockers having an ethylenically unsaturated reactive group can be any known UV light blocker having an ethylenically unsaturated reactive group. In an illustrative embodiment, as may be combined with one or more of the preceding paragraphs, a UV light blocker for use herein can comprise a phenolic group having a hydroxyl moiety and one or more ethylenically unsaturated reactive groups. In a non-limiting illustrative embodiment, a UV light blocker comprising a phenolic group having a protected hydroxyl moiety and one or more ethylenically unsaturated reactive groups can be represented by a benzotriazole compound having a structure of Formula XIV:

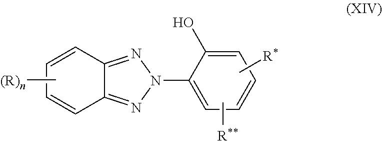

wherein each R is independently hydrogen, a halogen, an —O— group, a nitro group, a nitrile group, a substituted or unsubstituted alkoxy group, a substituted or unsubstituted hydroxyl group, a substituted or unsubstituted amine group, a substituted or unsubstituted carbonyl group, and a substituted or unsubstituted hydrocarbyl group, R* is hydrogen or a substituted or unsubstituted hydrocarbyl group, and R** is an ethylenically unsaturated reactive group.

As used herein, recitations of “substituted” group, means a group such as an alkyl group, cycloalkyl group, heterocycloalkyl group, aryl group, and/or heteroaryl group, in which at least one hydrogen atom thereof has been optionally replaced or substituted with a group that is other than hydrogen, such as, for example, halo groups (e.g., F, Cl, I, and Br), hydroxyl groups, ether groups, thiol groups, thio ether groups, carboxylic acid groups, carboxylic acid ester groups, phosphoric acid groups, phosphoric acid ester groups, sulfonic acid groups, sulfonic acid ester groups, nitro groups, cyano groups, hydrocarbyl groups (e.g., alkyl; alkenyl; alkynyl; cycloalkyl, including poly-fused-ring cycloalkyl and polycyclocalkyl; heterocycloalkyl; aryl, including hydroxyl substituted aryl, such as phenol, and including poly-fused-ring aryl; heteroaryl, including poly-fused-ring heteroaryl; and aralkyl groups), and amine groups.

As used herein, recitations of “linear or branched” groups, such as linear or branched alkyl, are herein understood to include, for example, groups that are linear, such as linear C₂ to C₃₀ alkyl groups; and groups that are appropriately branched, such as branched C₃ to C₃₀ alkyl groups.

Representative examples of halogen groups include, by way of example, Cl, I, F, and Br.

Representative examples of hydrocarbyl groups include linear or branched alkyl groups, linear or branched alkenyl groups, linear or branched alkynyl groups, cycloalkyl groups, heterocycloalkyl groups, aryl groups (including polycyclic aryl groups), heteroaryl groups (having at least one hetero atom in the aromatic ring); and aralkyl groups as defined herein.

Representative examples of alkoxy groups for use herein include, by way of example, an alkyl group as defined herein attached via oxygen linkage to the rest of the molecule, i.e., of the general formula —OR¹, wherein R¹ is an alkyl, cycloalkyl, or aromatic group as defined herein, e.g., —OCH₃, —OC₂H₅, or —OC₆H₅ which may be substituted or unsubstituted, and the like.

Representative examples of alkyl groups for use herein include, by way of example, a linear or branched hydrocarbon chain radical containing carbon and hydrogen atoms of from 1 to about 30 carbon atoms or from 1 to 12 carbon atoms or from 1 to 6 carbon atoms with or without unsaturation, to the rest of the molecule, e.g., methyl, ethyl, n-propyl, 1-methylethyl (isopropyl), n-butyl, n-pentyl, etc., and the like.

Representative examples of alkenyl groups for use herein include, by way of example, a straight or branched hydrocarbon chain radical containing from about 3 to about 30 carbon atoms with at least one carbon-carbon double bond such as, for example, propenyl, butenyl, pentenyl and the like.

Representative examples of alkynyl groups for use herein include, by way of example, a straight or branched hydrocarbon chain radical containing from about 3 to about 30 carbon atoms with at least one carbon-carbon triple bond such as, for example, propynyl, butynyl, pentynyl and the like.

Representative examples of cycloalkyl groups for use herein include, by way of example, a substituted or unsubstituted non-aromatic mono or multicyclic ring system of about 3 to about 30 carbon atoms or from 3 to 12 carbon atoms or from 3 to 6 carbon atoms such as, for example, cyclopropyl, cyclobutyl, cyclopentyl, cyclohexyl, perhydronapththyl, adamantyl and norbornyl groups bridged cyclic group or sprirobicyclic groups, e.g., sprio-(4, 4)-non-2-yl and the like, optionally containing one or more heteroatoms, e.g., O and N, and the like.

Representative examples of heterocyclic groups for use herein include, by way of example, a substituted or unsubstituted stable 3 to about 15 membered ring radical, containing carbon atoms and from one to five heteroatoms, e.g., nitrogen, phosphorus, oxygen, sulfur and mixtures thereof. Suitable heterocyclic ring radicals for use herein may be a monocyclic, bicyclic or tricyclic ring system, which may include fused, bridged or spiro ring systems, and the nitrogen, phosphorus, carbon, oxygen or sulfur atoms in the heterocyclic ring radical may be optionally oxidized to various oxidation states. Examples of such heterocyclic groups include, but are not limited to, azetidinyl, acridinyl, benzodioxolyl, benzodioxanyl, benzofurnyl, carbazolyl, cinnolinyl, dioxolanyl, indolizinyl, naphthyridinyl, perhydroazepinyl, phenazinyl, phenothiazinyl, phenoxazinyl, phthalazinyl, pyridyl, pteridinyl, purinyl, quinazolinyl, quinoxalinyl, quinolinyl, isoquinolinyl, tetrazoyl, imidazolyl, tetrahydroisouinolyl, piperidinyl, piperazinyl, 2-oxopiperazinyl, 2-oxopiperidinyl, 2-oxopyrrolidinyl, 2-oxoazepinyl, azepinyl, pyrrolyl, 4-piperidonyl, pyrrolidinyl, pyrazinyl, pyrimidinyl, pyridazinyl, oxazolyl, oxazolinyl, oxasolidinyl, triazolyl, indanyl, isoxazolyl, isoxasolidinyl, morpholinyl, thiazolyl, thiazolinyl, thiazolidinyl, isothiazolyl, quinuclidinyl, isothiazolidinyl, indolyl, isoindolyl, indolinyl, isoindolinyl, octahydroindolyl, octahydroisoindolyl, quinolyl, isoquinolyl, decahydroisoquinolyl, benzimidazolyl, thiadiazolyl, benzopyranyl, benzothiazolyl, benzooxazolyl, furyl, tetrahydrofurtyl, tetrahydropyranyl, thienyl, benzothienyl, thiamorpholinyl, thiamorpholinyl sulfoxide, thiamorpholinyl sulfone, dioxaphospholanyl, oxadiazolyl, chromanyl, isochromanyl and the like and mixtures thereof.

Representative examples of aryl groups for use herein include, by way of example, a substituted or unsubstituted monoaromatic or polyaromatic radical containing from about 5 to about 30 carbon atoms or from 5 to 12 carbon atoms or from 5 to 8 carbon atoms such as, for example, phenyl, naphthyl, tetrahydronapthyl, indenyl, biphenyl and the like, optionally containing one or more heteroatoms, e.g., O and N, and the like.

Representative examples of heteroaryl groups for use herein include, by way of example, a substituted or unsubstituted stable 5 to about 30 membered monoaromatic or polyaromatic radical, containing carbon atoms and from one to five heteroatoms, e.g., nitrogen, phosphorus, oxygen, sulfur and mixtures thereof.

Representative examples of fused ring polycyclic-aryl-alkyl groups and similar terms such as, fused ring polycyclic-alkyl-aryl groups, fused ring polycyclo-aryl-alkyl groups, and fused ring polycyclo-alkyl-aryl groups means a fused ring polycyclic group that includes at least one aryl ring and at least one cycloalkyl ring that are fused together to form a fused ring structure. For purposes of non-limiting illustration, examples of fused ring polycyclic-aryl-alkyl groups include, but are not limited to indenyl, 9H-flourenyl, cyclopentanaphthenyl, and indacenyl.

Representative examples of aralkyl groups as used herein, and in accordance with some embodiments, include, but are not limited to, C₆ to C₂₄ aralkyl, such as a C₆ to C₁₀ aralkyl, and means an aryl group substituted with an alkyl group.

Representative examples of amine groups for use herein include, by way of example, an amine of the general formula —R²NR³R⁴ wherein R², R³ and R⁴ are independently hydrogen or a C₁-C₃₀ hydrocarbon such as, for example, alkyl groups, aromatic groups, or cycloalkyl groups as defined herein, and the like.

The term “carbonyl group” as used herein is a divalent group represented by the formula —C(═O).

Representative examples of ethylenically unsaturated reactive groups for use herein include, by way of example, a (meth)acrylate-containing reactive end group, a (meth)acrylamide-containing reactive end group, an allyl-containing reactive end group, a vinyl-containing reactive end group, a vinylcarbonate-containing reactive end group, a vinylcarbamate-containing reactive end group, a styrene-containing reactive end group, an itaconate-containing reactive end group, a vinyloxy-containing reactive end group, a fumarate-containing reactive end group, a maleimide-containing reactive end group, a vinylsulfonyl reactive end group and the like.

In a non-limiting illustrative embodiment, a (meth)acrylate-containing reactive end group can be represented by the structure:

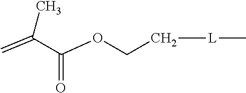

wherein L is a linking group or bond. Suitable linking groups include, for example, a heteroatom such as O, any divalent hydrocarbon radical or moiety such as independently a straight or branched, substituted or unsubstituted C₁-C₆ alkyl group, a substituted or unsubstituted C₃-C₁₂ cycloalkyl group, a substituted or unsubstituted C₄-C₁₂ cycloalkylalkyl group, a substituted or unsubstituted C₃-C₁₂ cycloalkenyl group, a substituted or unsubstituted C₆-C₁₂ aryl group, a substituted or unsubstituted C₇-C₁₂ arylalkyl group and substituted and unsubstituted ether-containing groups.

In an illustrative embodiment, R and R* are each hydrogen and R** is a (meth)acrylate-containing reactive end group.

In another illustrative embodiment, as may be combined with one or more of the preceding paragraphs, R** is positioned on the aromatic ring in the para position relative to the OH moiety.

The foregoing UV light blockers for use herein are known and either commercially available from such sources as, for example, Aldrich, Polysciences, Gelest, and Melrob, or can be made by methods within the purview of one skilled in the art.

In non-limiting illustrative embodiments, suitable UV light blockers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d][1,2,3]triazol-2-yl)phenoxy)ethyl methacrylate.

In one illustrative embodiment, suitable UV light blockers include, for example, one or more compounds of the following formulae:

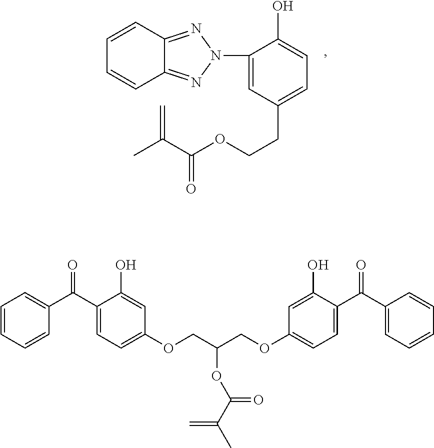 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1-[(4-benzoyl3-hydroxyphenoxy)methyl ester),

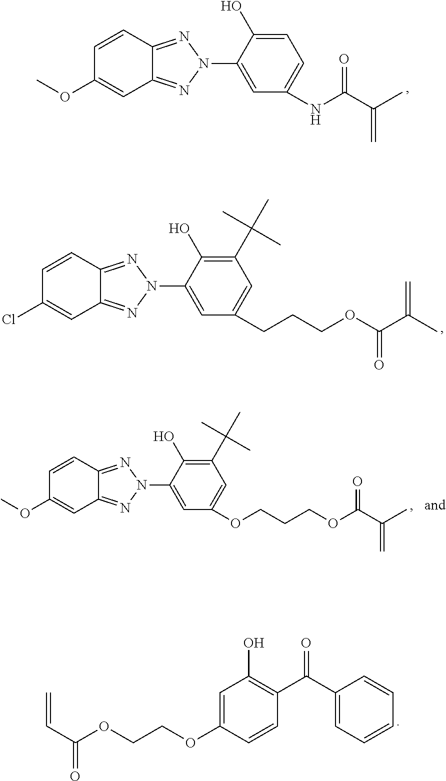

The foregoing UV light blockers are merely illustrative and not intended to be limiting. Any known UV light blocker comprising a phenolic group having a hydroxyl moiety and one or more ethylenically unsaturated reactive groups or later developed UV light blocker comprising a phenolic group having a hydroxyl moiety and one or more ethylenically unsaturated reactive groups are contemplated for use herein.

In some embodiments, the silicone ophthalmic device-forming monomeric mixture can contain from about 0.4 wt. % to about 4 wt. %, based on the total weight of the silicone ophthalmic device-forming monomeric mixture, of the one or more UV light blockers. In some embodiments, the silicone ophthalmic device-forming monomeric mixture can contain from about 1 wt. % to about 2 wt. %, based on the total weight of the silicone ophthalmic device-forming monomeric mixture, of the one or more UV light blockers.

In accordance with one or more additional non-limiting illustrative embodiments, as may be combined with one or more of the preceding paragraphs, the silicone ophthalmic device-forming monomeric mixture can further contain a blue-light blocker having an ethylenically unsaturated reactive group. Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference.

In non-limiting illustrative embodiments, a class of blue light blockers can comprise a phenolic group comprising a hydroxyl moiety and one or more ethylenically unsaturated reactive groups represented by an acridone compound having a structure of Formula XV:

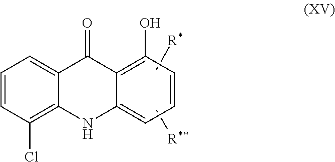

wherein R* and R** are as defined above.

In an illustrative embodiment, R* is hydrogen and R** is a (meth)acrylate-containing reactive end group as defined above.

In another illustrative embodiment, as may be combined with one or more of the preceding paragraphs, R** is positioned on the aromatic ring in the para position relative to the OH moiety.

The foregoing blue light blockers for use herein are known and either commercially available from such sources as, for example, Vishwa-Syntharo PharmaCompany, or can be made by methods within the purview of one skilled in the art.

The foregoing one or more blue light blockers comprising a phenolic group having a hydroxyl moiety and one or more ethylenically unsaturated reactive groups are merely illustrative and not intended to be limiting. Any known blue light blockers comprising a phenolic group having a hydroxyl moiety and one or more ethylenically unsaturated reactive groups or later developed blue light blockers comprising a phenolic group having a hydroxyl moiety and one or more ethylenically unsaturated reactive groups are contemplated for use herein.

In some embodiments, a blue-light blocker is N-2-[3-(2′-methylphenylazo)-4-hydroxyphenyl]ethyl methacrylamide.

In illustrative embodiments, the blue-light absorbers can be present in the silicone ophthalmic device-forming monomeric mixture in an amount ranging from about 0.005 wt. % to about 1 wt. %, based on the total weight of the silicone ophthalmic device-forming monomeric mixture. In another illustrative embodiment, the blue-light absorbers can be present in the silicone ophthalmic device-forming monomeric mixture in an amount ranging from about 0.01 wt. % to about 1 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture can further contain a diluent. Suitable diluents include, for example, at least one or more boric acid esters of a C₁ to C₈ monohydric alcohol, water-soluble or partly water-soluble monohydric alcohols and mixtures thereof. In one embodiment, a diluent includes, for example, at least one or more boric acid esters of a C₁ to C₅ monohydric alcohol. Suitable boric acid esters of a C₁ to C₈ monohydric alcohol include, for example, trimethyl borate, triethyl borate, tri-n-propyl borate, triisopropyl borate, tri-n-butyl borate, and tri-tert-butyl borate. Suitable water-soluble or partly water-soluble monohydric alcohols include, for example, monohydric alcohols having from 1 to 5 carbon atoms such as methanol, ethanol, isopropyl alcohol, 1-propanol, t-butyl alcohol, 2-butyl alcohol, 2-methyl-1-propanol, t-amyl alcohol and other C₅ isomers.

In non-limiting illustrative embodiments, as may be combined with one or more of the preceding paragraphs, the silicone ophthalmic device-forming monomeric mixture contains about 5 wt. % to about 50 wt. % of the diluent, based on the total weight of the silicone ophthalmic device-forming monomeric mixture. In one embodiment, the silicone ophthalmic device-forming monomeric mixture contains about 15 wt. % to about 30 wt. % of the diluent, based on the total weight of the silicone ophthalmic device-forming monomeric mixture.

The silicone ophthalmic device-forming monomeric mixture may further contain, as necessary and within limits not to impair the purpose and effect of the illustrative embodiments, various additives such as an antioxidant, coloring agent, lubricant, internal wetting agent, toughening agent and the like and other constituents as are well known in the art.

In non-limiting illustrative embodiments, as may be combined with one or more of the preceding paragraphs, the silicone ophthalmic devices disclosed herein can be a high-water content silicone ophthalmic device such as a silicone hydrogel having an equilibrium water content of at least about 35 wt. %. In another illustrative embodiment, the high-water content silicone ophthalmic device disclosed herein can have an equilibrium water content of at least about 50 wt. %. In another illustrative embodiment, the high-water content silicone ophthalmic device disclosed herein can have an equilibrium water content of at least about 60 wt. %. In another illustrative embodiment, the high-water content silicone ophthalmic device disclosed herein can have an equilibrium water content of at least about 70 wt. %. In another illustrative embodiment, the surface modified silicone ophthalmic devices disclosed herein can be a high-water content silicone ophthalmic device having an equilibrium water content of from about 35 wt. % to about 80 wt. %.

The silicone ophthalmic devices of the illustrative embodiments, e.g., silicone contact lenses or silicone intraocular lenses, can be prepared by polymerizing the foregoing silicone ophthalmic device-forming monomeric mixtures to form a product that can be subsequently formed into the appropriate shape by, for example, lathing, injection molding, compression molding, cutting and the like. For example, in producing silicone contact lenses, the initial silicone ophthalmic device-forming monomeric mixture may be polymerized in tubes to provide rod-shaped articles, which are then cut into buttons. The buttons may then be lathed into contact lenses.

Alternately, the silicone ophthalmic devices such as silicone contact lenses may be cast directly in molds, e.g., polypropylene molds, from the silicone ophthalmic device-forming monomeric mixtures by, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the mixtures to be polymerized to a mold, and spinning the mold in a controlled manner while exposing the mixture to a radiation source such as UV light. Static casting methods involve charging the silicone ophthalmic device-forming monomeric mixture between two mold sections, one mold section shaped to form the anterior lens surface and the other mold section shaped to form the posterior lens surface, and curing the mixture while retained in the mold assembly to form a lens, for example, by free radical polymerization of the mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a silicone ophthalmic device-forming monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat (thermal cure) and/or radiation, such as ultraviolet light, visible light, or high energy radiation. A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the initiator will be employed in the silicone ophthalmic device-forming monomeric mixture at a concentration of about 0.01 to about 5 wt. % of the total mixture.

Polymerization is generally performed in a reaction medium, such as, for example, a solution or dispersion using a solvent, e.g., water or an alkanol containing from 1 to 4 carbon atoms such as methanol, ethanol or propan-2-ol. Alternatively, a mixture of any of the above solvents may be used.

Generally, polymerization can be carried out for about 15 minutes to about 72 hours, and under an inert atmosphere of, for example, nitrogen or argon. If desired, the resulting polymerization product can be dried under vacuum, e.g., for about 5 to about 72 hours, or left in an aqueous solution prior to use.

Polymerization of the silicone ophthalmic device-forming monomeric mixtures will yield a polymer, that when hydrated, preferably forms a silicone hydrogel. When producing a silicone hydrogel lens, the silicone ophthalmic device-forming monomeric mixture may further include at least a diluent as discussed above that is ultimately replaced with water when the polymerization product is hydrated to form a hydrogel. Generally, the water content of the hydrogel is as described hereinabove, i.e., at least about 35 wt. %. The amount of diluent used should be less than about 50 wt. % and in most cases, the diluent content will be less than about 30 wt. %. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol; glycerine; liquid poly(ethylene glycol); alcohols; alcohol/water mixtures; ethylene oxide/propylene oxide block copolymers; low molecular weight linear poly(2-hydroxyethyl methacrylate); glycol esters of lactic acid; formamides; ketones; dialkylsulfoxides; butyl carbitol; borates as discussed herein and the like and mixtures thereof.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. If desired, the mixture used to produce the hydrogel lens may further include wetting agents known in the prior art for making hydrogel materials.

In the case of intraocular lenses, the silicone ophthalmic device-forming monomeric mixtures to be polymerized may further include a monomer for increasing the refractive index of the resultant polymerized product. Examples of such monomers include aromatic (meth) acrylates, such as phenyl (meth)acrylate, 2-phenylethyl (meth)acrylate, 2-phenoxyethyl methacrylate, and benzyl (meth)acrylate.

In non-limiting illustrative embodiments, as may be combined with one or more of the preceding paragraphs, the silicone ophthalmic devices such as silicone contact lenses disclosed herein demonstrate sufficient blocking of UV light to meet both FDA Class I and II specifications for UV blocking. Class I contact lenses must block more than 90% of UVA i.e., 316 to 380 nm, radiation and 99% of UVB, i.e., 280 to 315 nm, radiation. Class II contact lenses must block more than 50% of UVA and 95% of UVB radiation.

The silicone ophthalmic devices such as contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

In non-limiting illustrative embodiments, as may be combined with one or more of the preceding paragraphs, the foregoing silicone ophthalmic device is then exposed to a cationic copolymer comprising (i) monomeric units derived from a cationic monomer having an ethylenically unsaturated reactive group, and (ii) monomeric units derived from a hydrophilic monomer having an ethylenically unsaturated reactive group to form a surface modified silicone ophthalmic device. The presence of the cationic groups in the cationic copolymers leads to interchain non-covalent interactions with the one or more anionic ophthalmic device forming monomers present in the silicone ophthalmic device thereby forming a surface coating.

In some embodiments, the cationic copolymer is a random cationic copolymer. In an illustrative embodiment, the random cationic copolymer is a brush cationic copolymer. The term “polymer brushes,” as used herein is understood to mean a polymer brush that contains polymer chains, one end of which is directly or indirectly tethered to a surface and another end of which is free to extend from the surface, somewhat analogous to the bristles of a brush.

Representative examples of applicable cationic monomers include cationic monomers represented by a structure of Formula XVI:

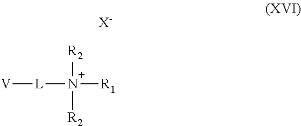

wherein L is a linking group, including, for example, a heteroatom such as O, any divalent hydrocarbon radical or moiety such as independently a straight or branched, substituted or unsubstituted C₁-C₆ alkyl group, a substituted or unsubstituted C₃-C₁₂ cycloalkyl group, a substituted or unsubstituted C₄-C₁₂ cycloalkylalkyl group, a substituted or unsubstituted C₃-C₁₂ cycloalkenyl group, a substituted or unsubstituted C₆-C₁₂ aryl group, a substituted or unsubstituted C₇-C₁₂ arylalkyl group and substituted and unsubstituted ether-containing groups.

X⁻ is at least a single charged counter ion. Examples of single charge counter ions include the group consisting of Cl⁻, Br⁻, I⁻, CF₃CO₂⁻, CH₃CO₂⁻, HCO₃⁻, CH₃SO₄⁻, p-toluenesulfonate, HSO₄⁻, H₂PO₄⁻, NO₃⁻, and CH₃CH(OH)CO₂⁻.

R₁, R₂ and R₃ are each independently hydrogen, or a hydrocarbyl group including, for example, a straight or branched C₁-C₃₀ alkyl group or a straight or branched C₁-C₆ alkyl group, a straight or branched C₁-C₃₀ fluoroalkyl group, C₁-C₂₀ ester group, ether containing group, polyether containing group, ureido group, amide group, amine group, substituted or unsubstituted C₁-C₃₀ alkoxy group, substituted or unsubstituted C₃-C₃₀ cycloalkyl group, substituted or unsubstituted C₃-C₃₀ cycloalkylalkyl group, substituted or unsubstituted C₃-C₃₀ cycloalkenyl group, substituted or unsubstituted C₅-C₃₀ aryl group, substituted or unsubstituted C₅-C₃₀ arylalkyl group, substituted or unsubstituted C₅-C₃₀ heteroaryl group, substituted or unsubstituted C₃-C₃₀ heterocyclic ring, substituted or unsubstituted C₄-C₃₀ heterocyclolalkyl group, a substituted or unsubstituted C₆-C₃₀ heteroarylalkyl group, fluorine group, a C₅-C₃₀ fluoroaryl group, or a hydroxyl group.

V is an ethylenically unsaturated reactive group. Suitable ethylenically unsaturated reactive groups for use herein include, for example, a (meth)acrylate-containing reactive end group, a (meth)acrylamide-containing reactive end group, an allyl-containing reactive end group, a vinyl-containing reactive end group, a vinylcarbonate-containing reactive end group, a vinylcarbamate-containing reactive end group, a styrene-containing reactive end group, an itaconate-containing reactive end group, a vinyloxy-containing reactive end group, a fumarate-containing reactive end group, a maleimide-containing reactive end group, a vinylsulfonyl reactive end group and the like.

Suitable cationic monomers having an ethylenically unsaturated reactive group include, for example, 3-methacrylamidopropyl-N,N,N-trimethyammonium salts and 2-methacryloyloxyethyl-N,N,N-trimethylammonium salts, 2-ethyldimethylammonioethyl methacrylate ethyl sulfate, diallyldimethylammonium chloride and the like.

Suitable hydrophilic monomers having a reactive functional group include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. In some embodiments, hydrophilic monomers having a reactive functional group for use herein are non-cationic hydrophilic monomers having a reactive functional group.

Representative examples of unsaturated carboxylic acids include, but are not limited to, methacrylic acid, acrylic acid and the like and mixtures thereof. Representative examples of acrylamides include, but are not limited to, alkylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), glycerol methacrylate and the like and mixtures thereof. Additional device-forming hydrophilic comonomers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable device-forming hydrophilic monomers will be apparent to one skilled in the art. Mixtures of the foregoing hydrophilic monomers can also be used.

In a non-limiting illustrative embodiment, a cationic copolymer containing monomeric units derived from 2-methacryloyloxyethyl-N,N,N-trimethylammonium salt and monomeric units derived from N,N-dimethylacrylamide can be represented by the following structure:

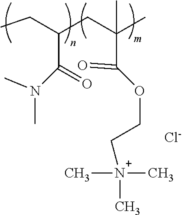

where n is from about 40 to about 90 and m is from about 10 to about 60.

The cationic copolymers can be prepared using free radical polymerization techniques with the structure of the polymer being completely random or controlled by the reactivity ratios of the respective monomers.

In some embodiments, a random cationic copolymer can be obtained by (1) mixing the cationic monomer having an ethylenically unsaturated reactive group and the hydrophilic monomer having an ethylenically unsaturated reactive group; (2) adding a polymerization initiator; (3) and subjecting the monomer/initiator mixture to a source of heat. The amount of the cationic monomer in the mixture can range from about 10 wt. % to about 60 wt. %, based on the total weight of the mixture, and the amount of the hydrophilic monomer can range from about 40 wt. % to about 90 wt. %, based on the total weight of the mixture.

Suitable initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN). A level of initiator employed will vary within the range of 0.01 wt. % to 2 wt. %, based on the total weight of the mixture. If desired, the mixture of the above-mentioned monomers is warmed with addition of a free-radical former.

Suitable polymerization conditions include, for example, a temperature of between about 40° C. to about 70° C. for a time period of about 10 hours to about 36 hours. If desired, the reaction can be carried out in the presence of a suitable solvent. Suitable solvents are in principle all solvents which dissolve the monomers used including, for example, 1,4-dioxane, hexanol, dimethylformamide; acetone, cyclohexanone, toluene, and the like and mixtures thereof.

As one skilled in the art will readily appreciate, the cationic copolymer disclosed herein can contain a balance of monomeric units derived from a cationic monomer having an ethylenically unsaturated reactive group and monomeric units derived from a hydrophilic monomer having an ethylenically unsaturated reactive group. In some embodiments, a cationic copolymer can include from about 10 to about 60 repeating units of the monomeric units derived from a cationic monomer having an ethylenically unsaturated reactive group and from about 40 to about 90 repeating units of the monomeric units derived from a hydrophilic monomer having an ethylenically unsaturated reactive group. In some embodiments, a cationic copolymer can have a number average molecular weight (as measured by GPC) of about 50,000 to about 2,000,000, or from about 100,000 to about 1,000,000.

In one or more additional non-limiting illustrative embodiments, as may be combined with one or more of the preceding paragraphs, a surface modified silicone ophthalmic device as disclosed herein is formed by exposing the silicone ophthalmic device to the cationic copolymer to form a surface coating on the silicone ophthalmic device. As mentioned above, the silicone ophthalmic devices disclosed herein are not subject to any lens extraction with an organic solvent to remove unpolymerized polymerizable components. Instead, an aqueous solution comprising water is used to extract the molded silicone hydrogel contact lenses disclosed herein. Accordingly, in some embodiments, the step of forming the surface coating can be carried out during a water extraction step using an aqueous solution comprising water and the cationic copolymer. For example, the step of forming can include extracting the silicone ophthalmic devices with an aqueous solution comprising water and the cationic copolymer to remove unwanted polymerization products or any non-reacted monomer from the polymerized device, and drying the water extracted lens under vacuum at a temperature from about 40° C. to about 110° C. for at least about 30 minutes. In some embodiments, the aqueous solution can contain the cationic copolymer in an amount of about 0.05 wt. % to about 1 wt. %.

In some embodiments, the silicone ophthalmic device can be released from a mold assembly and then contacted with an aqueous packaging solution containing a cationic copolymer disclosed herein. For example, the silicone ophthalmic device can be transferred to an individual lens package containing a buffered saline solution and at least the cationic copolymer disclosed herein and subjected to sterilization. In non-limiting illustrative embodiments, the cationic copolymer disclosed herein can be present in the aqueous packaging solution in an amount ranging from about 0.02 wt. % to about 1 wt. %, based on the total weight of the aqueous packaging solution. In some embodiments, the cationic copolymer disclosed herein can be present in the aqueous packaging solution in an amount ranging from about 0.05 wt. % to about 0.5 wt. %, based on the total weight of the aqueous packaging solution.

Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, steam sterilizing or autoclaving of the sealed container at temperatures of about 120° C. or higher.

The packaging solutions of the illustrative embodiments are physiologically compatible. Specifically, the solution must be “ophthalmically safe” for use with a lens such as a contact lens, meaning that a contact lens treated with the solution is generally suitable and safe for direct placement on the eye without rinsing, that is, the solution is safe and comfortable for daily contact with the eye via a contact lens that has been wetted with the solution. An ophthalmically safe solution has a tonicity and pH that is compatible with the eye and includes materials, and amounts thereof, that are non-cytotoxic according to ISO standards and U.S. Food & Drug Administration (FDA) regulations.

The packaging solution should also be sterile in that the absence of microbial contaminants in the product prior to release must be statistically demonstrated to the degree necessary for such products. The liquid media useful in the present invention are selected to have no substantial detrimental effect on the lens being treated or cared for and to allow or even facilitate the present lens treatment or treatments. The liquid media are preferably aqueous-based. A particularly useful aqueous liquid medium is that derived from saline, for example, a conventional saline solution or a conventional buffered saline solution.

The pH of the present solutions is maintained within the range of about 6 to about 9, and preferably about 6.5 to about 7.8. As mentioned above, additional buffer may optionally be added, such as boric acid, sodium borate, potassium citrate, sodium citrate, citric acid, sodium bicarbonate, various mixed phosphate buffers (including combinations of Na₂ HPO₄, NaH₂ PO₄ and KH₂ PO₄), hydrates thereof and the like and mixtures thereof. Generally, buffers will be used in amounts ranging from about 0.05 to about 2.5 percent by weight, and preferably from about 0.1 to about 1.5 percent by weight of the solution. However, according to certain embodiments, tris(hydroxymethyl)aminomethane, or salts thereof, function as the sole buffer.

In one embodiment, the aqueous packaging solution can further comprise one or more buffer agents. Suitable one or more buffer agents include, for example, phosphate buffer agents, borate buffer agents, citrate buffer agents, and the like. A suitable phosphate buffer agent can be any known phosphate buffer agents. In one embodiment, the phosphate buffer agent comprises one or more of sodium hydrogen phosphate monobasic, sodium hydrogen phosphate dibasic, potassium hydrogen phosphate monobasic and potassium hydrogen phosphate dibasic and any suitable hydrate thereof, e.g., monohydrate and heptahydrate. A suitable borate buffer agent can be any known borate buffer agents. In one embodiment, the borate buffer agent comprises one or more of boric acid and sodium borate. A suitable citrate buffer agent can be any known citrate buffer agents. In one embodiment, the citrate buffer agent comprises one or more of citric acid and sodium citrate.

In one embodiment, the one or more buffer agents are present in the aqueous packaging solution in an amount ranging from about 0.001 wt. % to about 2 wt. %, based on the total weight of the packaging solution. In one embodiment, the phosphate buffer agent is present in the packaging solution in an amount ranging from about 0.001 wt. % to about 1 wt. %, based on the total weight of the packaging solution.

Typically, the aqueous packaging solutions are also adjusted with tonicity agents, to approximate the osmotic pressure of normal lacrimal fluids which is equivalent to a 0.9 percent solution of sodium chloride or 2.5 percent of glycerol solution. The solutions are made substantially isotonic with physiological saline used alone or in combination, otherwise if simply blended with sterile water and made hypotonic or made hypertonic the lenses will lose their desirable optical parameters. Correspondingly, excess saline may result in the formation of a hypertonic solution which will cause stinging and eye irritation.

Examples of suitable tonicity adjusting agents include, but are not limited to, sodium and potassium chloride, dextrose, glycerin, calcium and magnesium chloride and the like and mixtures thereof. These agents are typically used individually in amounts ranging from about 0.01 to about 2.5% w/v and preferably from about 0.2 to about 1.5% w/v. Preferably, the tonicity agent will be employed in an amount to provide a final osmotic value of at least about 200 mOsm/kg, or from about 200 to about 400 mOsm/kg, or from about 250 to about 350 mOsm/kg, or from about 280 to about 320 mOsm/kg.

If desired, one or more additional components can be included in the packaging solution. Such an additional component or components are chosen to impart or provide at least one beneficial or desired property to the packaging solution. Such additional components may be selected from components which are conventionally used in one or more ophthalmic device care compositions. Examples of such additional components include cleaning agents, wetting agents, nutrient agents, sequestering agents, viscosity builders, contact lens conditioning agents, antioxidants, and the like and mixtures thereof. These additional components may each be included in the packaging solutions in an amount effective to impart or provide the beneficial or desired property to the packaging solutions. For example, such additional components may be included in the packaging solutions in amounts similar to the amounts of such components used in other, e.g., conventional, contact lens care products.

Useful sequestering agents include, but are not limited to, disodium ethylene diamine tetraacetate, alkali metal hexametaphosphate, citric acid, sodium citrate and the like and mixtures thereof.

Useful viscosity builders include, but are not limited to, hydroxyethyl cellulose, hydroxymethyl cellulose, polyvinyl pyrrolidone, polyvinyl alcohol and the like and mixtures thereof.

Useful antioxidants include, but are not limited to, sodium metabisulfite, sodium thiosulfate, N-acetylcysteine, butylated hydroxyanisole, butylated hydroxytoluene and the like and mixtures thereof.

The method of packaging and storing a silicone ophthalmic device such as a silicone contact lens includes at least packaging a silicone ophthalmic device immersed in the aqueous packaging solution containing the cationic copolymer disclosed herein and sterilizing the packaged solution. The method may include immersing the silicone ophthalmic device in the aqueous packaging solution containing the cationic copolymer disclosed herein prior to delivery to the customer/wearer, directly following manufacture of the contact lens. Alternately, the packaging and storing in the aqueous packaging solution containing the cationic copolymer disclosed herein may occur at an intermediate point before delivery to the ultimate customer (wearer) but following manufacture and transportation of a contact lens in a dry state, wherein a dry contact lens is hydrated by immersing the contact lens in the aqueous packaging solution containing the cationic copolymer disclosed herein.

The resulting surface modified silicone ophthalmic device can then be used “as is”. In other words, no additional surface treatment steps will have to be carried out to modify the resulting surface modified silicone ophthalmic device. As used herein, the phrase “without any additional surface treatment steps” shall be understood to mean that the exterior surface of the surface modified silicone ophthalmic device of the illustrative embodiments is not further treated to modify the surface thereof by, for example, oxidation treatments, plasma treatments, grafting treatments, coating treatments and the like. However, it shall be understood that coatings such as color or other cosmetic enhancement may be applied to the silicone ophthalmic devices disclosed herein.

The following examples are provided to enable one skilled in the art to practice the invention and are merely illustrative. The examples should not be read as limiting the scope of the invention as defined in the claims.

In the examples, the following abbreviations are used.
NVP: N-vinyl-2-pyrrolidone.
DMA: Dimethylacrylamide.
MEMA: 2-Methoxyethyl methacrylate or Ethylene glycol methyl ether
methacrylate
EGDMA: Ethylene glycol dimethacrylate.
MAA: Methacrylic acid.
UV416: 2-(4-Benzoyl-3-hydroxyphenoxy)ethyl acrylate.
Vazo™ 64: azo bis-isobutylnitrile (AIBN).
Vazo-56 [2,2′-azobis(2-methylpropionamidine) HCl].
IMVT: 1,4-bis(4-(2-methacryloxyethyl)phenylamino)anthraquinone.
META: [2-methacryloxylethyl]trimethylammonium chloride.
CTA: Mercaptoethanol.
SA monomer: A compound having the structure:

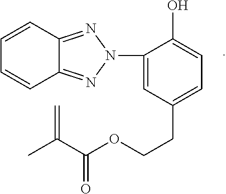 [SMILES: C=C(C)C(=O)OCCc1ccc(O)c(-n2nc3ccccc3n2)c1]

X-22-1666: A compound having the following structure:

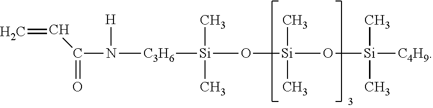

X-22-1666C: A compound available from ShinEtsu and having the following structure:

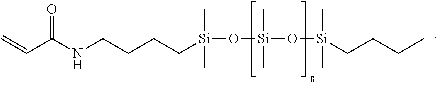

Tris-MA: tris(trimethylsiloxy)silylpropyl methacrylate.

Various polymerization products were formed as discussed below and characterized by a standard testing procedure such as:

Captive Bubble Contact Angle (CBCA): Captive bubble contact angle data was collected on a First Ten Angstroms FTA-1000 prop Shape Instrument. All samples were rinsed in HPLC grade water prior to analysis in order to remove components of the packaging solution from the sample surface. Prior to data collection the surface tension of the water used for all experiments was measured using the pendant drop method. In order for the water to qualify as appropriate for use, a surface tension value of 70-72 dynes/cm was expected. All lens samples were placed onto a curved sample holder and submerged into a quartz cell filled with HPLC grade water. Advancing and receding captive bubble contact angles were collected for each sample. The advancing contact angle is defined as the angle measured in water as the air bubble is retracting from the lens surface (water is advancing across the surface). All captive bubble data was collected using a high-speed digital camera focused onto the sample/air bubble interface. The contact angle was calculated at the digital frame just prior to contact line movement across the sample/air bubble interface. The receding contact angle is defined as the angle measured in water as the air bubble is expanding across the sample surface (water is receding from the surface).

### Examples 1-3

A silicone ophthalmic device-forming monomeric mixture was made by mixing the following components, listed in Table 1 at amounts per weight.

TABLE 1

| Formulation | Ex. 1 | Ex. 2 | Ex. 3 |
|---|---|---|---|
| NVP | 41.00 | 43.50 | 46.18 |
| MEMA | 5.40 | 5.40 | 5.40 |
| EGDMA | 0.84 | 0.84 | 0.75 |
| MAA | 5.00 | 2.50 | 5.00 |
| X-22-1666C | 20.00 | 20.00 | 40.00 |
| X-22-1666 | 25.00 | 25.00 | — |
| Vazo 64 | 0.20 | 0.20 | 0.40 |
| SA Monomer | 1.25 | 1.25 | 1.25 |
| UV-416 | 1.00 | 1.00 | 1.00 |
| Chloroacridone | 0.25 | 0.25 | — |
| IMVT | 0.02 | 0.02 | 0.02 |

The silicone ophthalmic device-forming monomeric mixture was cast into contact lenses by introducing the monomeric mixture to a polypropylene mold assembly. Then, the mold assembly and monomeric mixture were thermally cured in an oven purged by nitrogen at room temperature for 30 minutes, then ramp up to 110° C. and hold for 45 minutes, then cooled down to 30° C. in about 20 minutes. The resultant silicone contact lenses were released from the mold assembly.

### Example 4

### Preparation of a Cationic Copolymer by the General Reaction Scheme.

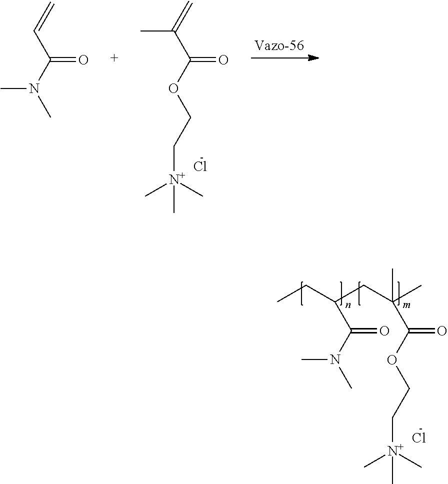

12.00 g of DMA, 33.52 g of META, 0.068 g of Vazo-56 (dissolved in a small amount of purified water and added to the flask) and 950 mL of purified water were placed in a 4-neck 2 L round bottom flask equipped with a condenser and purging needle. The solution was purged with nitrogen for 1 hour and then placed in a preheated oil bath at 65° C. overnight with continuous purging. The solution was cooled and poured into a plastic amber bottle. The value of n is 50 and m is 50. The copolymer had a number average molecular weight of about 223,000 daltons (Da) as measured by Gel Permeation Chromatography (GPC).

### Example 5

### Preparation of a Cationic Copolymer by the General Reaction Scheme.

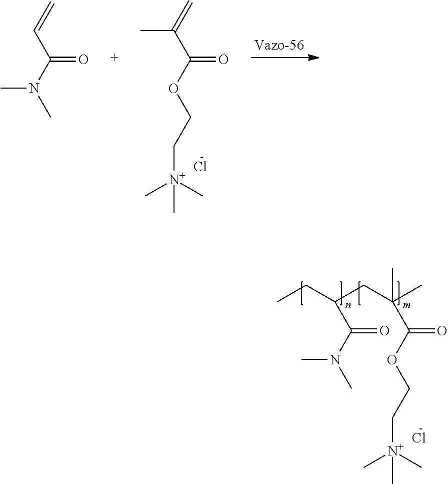

11.28 g of DMA, 10.50 g of META, 0.027 g of Vazo-56 (dissolved in a small amount of purified water and added to the flask) and 430 mL of purified water were placed in a 3-neck 1 L round bottom flask equipped with a condenser and purging needle. The solution was purged with nitrogen for 1 hour and then placed in a preheated oil bath at 65° C. overnight with continuous purging. The solution was cooled and poured into a plastic amber bottle. The value of n is 75 and m is 25. The copolymer had a number average molecular weight of about 234,000 Da as measured by Gel Permeation Chromatography (GPC).

### Example 6

### Preparation of a Cationic Copolymer by the General Reaction Scheme.

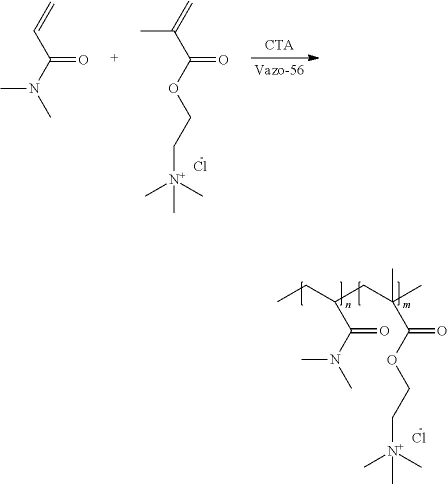

15.04 g of DMA, 10.50 g of META, 0.0025 g of mercaptoethanol (CTA) and 0.001 g of Vazo-56 (both were dissolved in a small amount of purified water and added to the flask) and 440 mL of purified water were placed in a 3-neck 1 L round bottom flask equipped with a condenser and purging needle. The solution was purged with nitrogen for 1 hour and then placed in a preheated oil bath at 65° C. overnight with continuous purging. The solution was cooled and poured into a plastic amber bottle. The value of n is 80 and m is 20. The copolymer had a number average molecular weight of about 128,000 Da as measured by Gel Permeation Chromatography (GPC).

### Example 7

### Preparation of a Cationic Copolymer by the General Reaction Scheme.

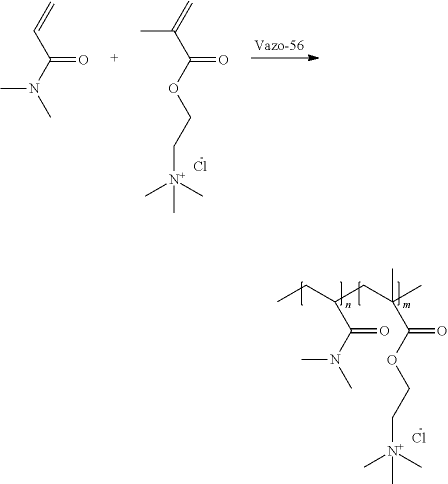

31.95 g of DMA, 15.77 g of META, 0.068 g of Vazo-56 (dissolved in a small amount of purified water and added to the flask) and 950 mL of purified water were placed in a 3-neck 1 L round bottom flask equipped with a condenser and purging needle. The solution was purged with nitrogen for 1 hour and then placed in a preheated oil bath at 65° C. overnight with continuous purging. The solution was cooled and poured into a plastic amber bottle. The value of n is 85 and m is 15. The copolymer had a number average molecular weight of about 245,000 Da as measured by Gel Permeation Chromatography (GPC).

### Examples 8-10

### Preparation of a Surface Modified Silicone Contact Lens.

The silicone contact lenses of Examples 1 and 2 were each packaged in a phosphate buffered saline with 0.2 wt. % of the copolymer of Examples 5 to 7 and autoclaved at 120° C. Contact angles were measured for the silicone contact lenses and are presented below in Table 2.

TABLE 2

| | Lens of Example 1 | Lens of Example 2 |
|---|---|---|
| | CBCA | CBCA |
| Packaged in 0.2 wt. % of | 59 | 56 |
| cationic copolymer of Ex. 5 | | |
| Packaged in 0.2 wt. % of | 63 | 51 |
| cationic copolymer of Ex. 6 | | |
| Packaged in 0.2 wt. % of | 47 | 45 |
| cationic copolymer of Ex. 7 | | |

As can be seen, the results in Table 2 show that the silicone contact lenses of Examples 1 and 2 exhibited acceptable surface wettability when packaged in the cationic copolymers of Examples 5-7.

### Example 11

### Preparation of a Surface Modified Silicone Contact Lens.

Silicone contact lenses made from different combinations of X22-1666 and X22-1666C as set forth below in Table 3 were each packaged in a phosphate buffered saline with 0.2 wt. % of the copolymer of Example 6 and autoclaved at 120° C. Contact angles were measured for the lenses and are further presented below in Table 3.

TABLE 3

| | Combination | |
|---|---|---|
| | X22-1666/X22- | |
| | 1666C in lens bulk | |
| Si % | formulation | CBCA |
| 35% | 15%/20% | 43 |
| 40% | 15%/25% | 51 |
| 40% | 20%/20% | 49 |
| 40% | 25%/15% | 43 |
| 45% | 15%/30% | 45 |
| 40% | 0%/40% | 44 |

As can be seen, the results in Table 3 show that the silicone contact lenses made from different combinations of X22-1666 and X22-1666C exhibited acceptable surface wettability when packaged in the cationic copolymer of Example 6.

### Examples 12 and 13

A silicone ophthalmic device-forming monomeric mixture was made by mixing the following components, listed in Table 4 at amounts per weight.

TABLE 4

| Formulation | Ex. 12 | Ex. 13 |
|---|---|---|
| NVP | 43.30 | 45.10 |
| MEMA | 5.40 | 5.40 |
| EGDMA | 0.45 | 0.45 |
| MAA | 8.00 | 6.00 |
| X-22-1666C | 25.00 | 25.00 |
| TRIS-MA | 15.00 | 15.10 |
| Vazo 64 | 0.40 | 0.40 |
| SA Monomer | 2.00 | 2.00 |
| UV-416 | 0.50 | 0.50 |
| IMVT | 0.02 | 0.02 |

The silicone ophthalmic device-forming monomeric mixture was cast into contact lenses by introducing the monomeric mixture to a polypropylene mold assembly. Then, the mold assembly and monomeric mixture were thermally cured in an oven purged by nitrogen at room temperature for 30 minutes, then ramp up to 110° C. and hold for 45 minutes, then cooled down to 30° C. in about 20 minutes. The resultant silicone contact lenses were released from the mold assembly and hydrated in water at 60° C. for a total of 6 minutes, then packaged and autoclaved at 120° C. in a phosphate buffer with 0.2 wt. % of the cationic copolymer of Example 6. The CBCA for each silicone contact lens was 41.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, +10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

According to an aspect of the present disclosure, a surface modified silicone ophthalmic device comprises:
a silicone ophthalmic device which is a polymerization product of a silicone ophthalmic device-forming monomeric mixture comprising:
(a) one or more hydrophilic monomers,
(b) one or more monofunctional silicone monomers represented by a structure of Formula I:

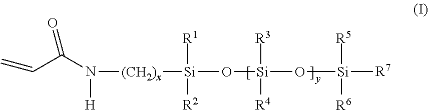

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15,
(c) one or more anionic ophthalmic device forming monomers, and
(d) one or more crosslinking agents, and
a surface coating on the silicone ophthalmic device, the surface coating comprising a cationic copolymer comprising (i) monomeric units derived from a cationic monomer having an ethylenically unsaturated reactive end group, and (ii) monomeric units derived from a hydrophilic monomer having an ethylenically unsaturated reactive group.

In non-limiting illustrative embodiments, as may be combined with one or more of the preceding paragraphs, the monomeric units derived from the cationic monomer are non-covalently attached to the one or more anionic ophthalmic device forming monomers.

In non-limiting illustrative embodiments, as may be combined with one or more of the preceding paragraphs, the cationic monomer having an ethylenically unsaturated reactive end group is represented by a structure of Formula II:

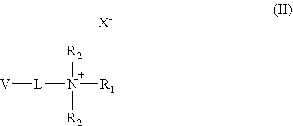

wherein L is a linking group, X⁻ is at least a single charged counter ion, R₁, R₂ and R₃ are each independently hydrogen, or a hydrocarbyl group and V is an ethylenically unsaturated reactive group.

In non-limiting illustrative embodiments, as may be combined with one or more of the preceding paragraphs, L is a divalent hydrocarbon radical, R₁, R₂ and R₃ are each independently, a straight or branched C₁-C₆ alkyl group and V is a (meth)acrylate-containing reactive end group.

In non-limiting illustrative embodiments, as may be combined with one or more of the preceding paragraphs, the cationic monomer having an ethylenically unsaturated reactive end group is a 2-methacryloyloxyethyl-N,N,N-trimethylammonium salt, 2-ethyldimethylammonioethyl methacrylate ethyl sulfate, or diallyldimethylammonium chloride.

In non-limiting illustrative embodiments, as may be combined with one or more of the preceding paragraphs, the hydrophilic monomer having an ethylenically unsaturated reactive group is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the hydrophilic monomer having an ethylenically unsaturated reactive group is one of a vinyl lactam or an acrylamide.

In non-limiting illustrative embodiments, as may be combined with one or more of the preceding paragraphs, the cationic copolymer comprises from about 10 to about 60 monomeric units derived from the cationic monomer having an ethylenically unsaturated reactive end group and from about 40 to about 90 monomeric units derived from the hydrophilic monomer having an ethylenically unsaturated reactive group.

In non-limiting illustrative embodiments, as may be combined with one or more of the preceding paragraphs, the cationic copolymer is a brush cationic copolymer.

In non-limiting illustrative embodiments, as may be combined with one or more of the preceding paragraphs, the cationic copolymer is a random cationic copolymer.

In non-limiting illustrative embodiments, as may be combined with one or more of the preceding paragraphs, the one or more hydrophilic monomers in the silicone ophthalmic device-forming monomeric mixture is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen or a C₁ to C₆ alkyl group; R⁵, R⁶ and R⁷ are independently a straight or branched C₁ to C₆ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 8.

In non-limiting illustrative embodiments, as may be combined with one or more of the preceding paragraphs, the one or more monofunctional silicone monomers includes a first monofunctional silicone monomer represented by Formula I and a second monofunctional silicone monomer represented by Formula I different than the first monofunctional silicone monomer.

In non-limiting illustrative embodiments, as may be combined with one or more of the preceding paragraphs, the one or more anionic ophthalmic device forming monomers include one or more of acrylic acid and methacrylic acid.

In non-limiting illustrative embodiments, as may be combined with one or more of the preceding paragraphs, the silicone ophthalmic device-forming monomeric mixture comprises:
about 5 wt. % to about 60 wt. %, based on the total weight of the silicone ophthalmic device-forming monomeric mixture, of the one or more hydrophilic monomers,
about 10 wt. % to about 55 wt. %, based on the total weight of the silicone ophthalmic device-forming monomeric mixture, of the monofunctional silicone monomer,
about 1 wt. % to about 10 wt. %, based on the total weight of the silicone ophthalmic device-forming monomeric mixture, of the one or more anionic ophthalmic device forming monomers, and
about 0.1 wt. % to about 10 wt. %, based on the total weight of the silicone ophthalmic device-forming monomeric mixture, of the one or more crosslinking agents.

In non-limiting illustrative embodiments, as may be combined with one or more of the preceding paragraphs, the silicone ophthalmic device-forming monomeric mixture further comprises one or more ultraviolet light blockers having an ethylenically unsaturated reactive group.

In non-limiting illustrative embodiments, as may be combined with one or more of the preceding paragraphs, the one or more ultraviolet light blockers having an ethylenically unsaturated reactive group comprise a phenolic group having a hydroxyl moiety and one or more ethylenically unsaturated reactive groups.

In non-limiting illustrative embodiments, as may be combined with one or more of the preceding paragraphs, the one or more ultraviolet light blockers having an ethylenically unsaturated reactive group comprise a benzotriazole compound having a structure of Formula III:

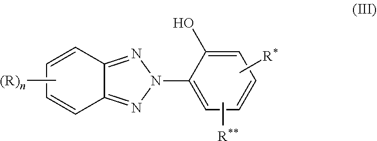

wherein each R is independently hydrogen, a halogen, an —O— group, a nitro group, a nitrile group, a substituted or unsubstituted alkoxy group, a substituted or unsubstituted hydroxyl group, a substituted or unsubstituted amine group, a substituted or unsubstituted carbonyl group, and a substituted or unsubstituted hydrocarbyl group, R* is hydrogen or a substituted or unsubstituted hydrocarbyl group, and R** is an ethylenically unsaturated reactive group.

In non-limiting illustrative embodiments, as may be combined with one or more of the preceding paragraphs, R and R* are each hydrogen and R** is a (meth)acrylate-containing reactive end group.

In non-limiting illustrative embodiments, as may be combined with one or more of the preceding paragraphs, R** is positioned on the aromatic ring in the para position relative to the OH moiety.

In non-limiting illustrative embodiments, as may be combined with one or more of the preceding paragraphs, the one or more ultraviolet light blockers having an ethylenically unsaturated reactive group are present in the silicone ophthalmic device-forming monomeric mixture in an amount of from about 0.4 wt. % to about 4 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further comprises one or more blue light blockers having an ethylenically unsaturated reactive group.

In non-limiting illustrative embodiments, as may be combined with one or more of the preceding paragraphs, the one or more blue light blockers are represented by an acridone compound having a structure of Formula IV:

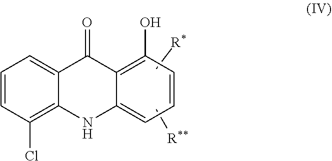

wherein R* is hydrogen or a substituted or unsubstituted hydrocarbyl group, and R** is an ethylenically unsaturated reactive group.

In non-limiting illustrative embodiments, as may be combined with one or more of the preceding paragraphs, the surface modified silicone ophthalmic device demonstrates sufficient blocking of UV light to meet at least FDA Class I specifications for UV blocking.

In non-limiting illustrative embodiments, as may be combined with one or more of the preceding paragraphs, the surface modified silicone ophthalmic device is a surface modified silicone contact lens.

In non-limiting illustrative embodiments, as may be combined with one or more of the preceding paragraphs, the surface modified silicone ophthalmic device is a surface modified silicone hydrogel.

According to another aspect of the present disclosure, a method for making a surface modified silicone ophthalmic device, comprises:
providing a silicone ophthalmic device which is a polymerization product of a silicone ophthalmic device-forming monomeric mixture comprising.
(a) one or more hydrophilic monomers,
(b) one or more monofunctional silicone monomers represented by a structure of Formula I:

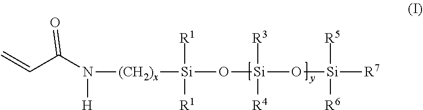

wherein R¹, R², R³ and R are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15,
(c) one or more anionic ophthalmic device forming monomers, and
(d) one or more crosslinking agents, and
exposing the silicone ophthalmic device to a cationic copolymer comprising (i) monomeric units derived from a cationic monomer having an ethylenically unsaturated reactive end group, and (ii) monomeric units derived from a hydrophilic monomer having an ethylenically unsaturated reactive group, thereby forming a surface coating on the silicone ophthalmic device.

In non-limiting illustrative embodiments, as may be combined with one or more of the preceding paragraphs, the cationic monomer having an ethylenically unsaturated reactive end group is represented by a structure of Formula II:

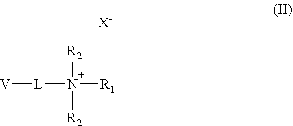

wherein L is a linking group, X⁻ is at least a single charged counter ion, R₁, R₂ and R₃ are each independently hydrogen, or a hydrocarbyl group and V is an ethylenically unsaturated reactive group.

In non-limiting illustrative embodiments, as may be combined with one or more of the preceding paragraphs, L is a divalent hydrocarbon radical, R₁, R₂ and R₃ are each independently, a straight or branched C₁-C₆ alkyl group and V is a (meth)acrylate-containing reactive end group.

In non-limiting illustrative embodiments, as may be combined with one or more of the preceding paragraphs, the cationic monomer having an ethylenically unsaturated reactive end group is a 2-methacryloyloxyethyl-N,N,N-trimethylammonium salt, 2-ethyldimethylammonioethyl methacrylate ethyl sulfate, or diallyldimethylammonium chloride.

In non-limiting illustrative embodiments, as may be combined with one or more of the preceding paragraphs, the hydrophilic monomer having an ethylenically unsaturated reactive group is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the hydrophilic monomer having an ethylenically unsaturated reactive group is one of a vinyl lactam or an acrylamide.

In non-limiting illustrative embodiments, as may be combined with one or more of the preceding paragraphs, the cationic copolymer comprises from about 10 to about 60 monomeric units derived from the cationic monomer having an ethylenically unsaturated reactive end group and from about 40 to about 90 monomeric units derived from the hydrophilic monomer having an ethylenically unsaturated reactive group.

In non-limiting illustrative embodiments, as may be combined with one or more of the preceding paragraphs, the cationic copolymer is a brush cationic copolymer.

In non-limiting illustrative embodiments, as may be combined with one or more of the preceding paragraphs, the cationic copolymer is a random cationic copolymer.

In non-limiting illustrative embodiments, as may be combined with one or more of the preceding paragraphs, the one or more hydrophilic monomers in the silicone ophthalmic device-forming monomeric mixture is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen or a C₁ to C₆ alkyl group; R⁵, R⁶ and R⁷ are independently a straight or branched C₁ to C₆ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 8.

In non-limiting illustrative embodiments, as may be combined with one or more of the preceding paragraphs, the one or more monofunctional silicone monomers includes a first monofunctional silicone monomer represented by Formula I and a second monofunctional silicone monomer represented by Formula I different than the first monofunctional silicone monomer.

In non-limiting illustrative embodiments, as may be combined with one or more of the preceding paragraphs, the one or more anionic ophthalmic device forming monomers include one or more of acrylic acid and methacrylic acid.

In non-limiting illustrative embodiments, as may be combined with one or more of the preceding paragraphs, the silicone ophthalmic device-forming monomeric mixture comprises:
about 5 wt. % to about 60 wt. %, based on the total weight of the silicone ophthalmic device-forming monomeric mixture, of the one or more hydrophilic monomers,
about 10 wt. % to about 55 wt. %, based on the total weight of the silicone ophthalmic device-forming monomeric mixture, of the monofunctional silicone monomer,
about 1 wt. % to about 10 wt. %, based on the total weight of the silicone ophthalmic device-forming monomeric mixture, of the one or more anionic ophthalmic device forming monomers, and
about 0.1 wt. % to about 10 wt. %, based on the total weight of the silicone ophthalmic device-forming monomeric mixture, of the one or more crosslinking agents.

In non-limiting illustrative embodiments, as may be combined with one or more of the preceding paragraphs, the silicone ophthalmic device-forming monomeric mixture further comprises one or more ultraviolet light blockers having an ethylenically unsaturated reactive group.

In non-limiting illustrative embodiments, as may be combined with one or more of the preceding paragraphs, the one or more ultraviolet light blockers having an ethylenically unsaturated reactive group comprise a phenolic group having a hydroxyl moiety and one or more ethylenically unsaturated reactive groups.

In non-limiting illustrative embodiments, as may be combined with one or more of the preceding paragraphs, the one or more ultraviolet light blockers having an ethylenically unsaturated reactive group comprise a benzotriazole compound having a structure of Formula III:

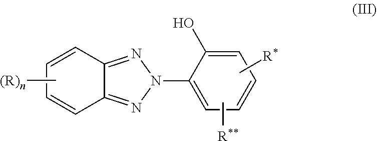

wherein each R is independently hydrogen, a halogen, an —O— group, a nitro group, a nitrile group, a substituted or unsubstituted alkoxy group, a substituted or unsubstituted hydroxyl group, a substituted or unsubstituted amine group, a substituted or unsubstituted carbonyl group, and a substituted or unsubstituted hydrocarbyl group, R* is hydrogen or a substituted or unsubstituted hydrocarbyl group, and R** is an ethylenically unsaturated reactive group.

In non-limiting illustrative embodiments, as may be combined with one or more of the preceding paragraphs, R and R* are each hydrogen and R** is a (meth)acrylate-containing reactive end group.

In non-limiting illustrative embodiments, as may be combined with one or more of the preceding paragraphs, R** is positioned on the aromatic ring in the para position relative to the OH moiety.

In non-limiting illustrative embodiments, as may be combined with one or more of the preceding paragraphs, the one or more ultraviolet light blockers having an ethylenically unsaturated reactive group are present in the silicone ophthalmic device-forming monomeric mixture in an amount of from about 0.4 wt. % to about 4 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further comprises one or more blue light blockers having an ethylenically unsaturated reactive group.

In non-limiting illustrative embodiments, as may be combined with one or more of the preceding paragraphs, the one or more blue light blockers are represented by an acridone compound having a structure of Formula IV:

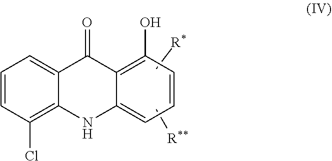

wherein R* is hydrogen or a substituted or unsubstituted hydrocarbyl group, and R** is an ethylenically unsaturated reactive group.

In non-limiting illustrative embodiments, as may be combined with one or more of the preceding paragraphs, the surface modified silicone ophthalmic device demonstrates sufficient blocking of UV light to meet at least FDA Class I specifications for UV blocking.

In non-limiting illustrative embodiments, as may be combined with one or more of the preceding paragraphs, the silicone ophthalmic device-forming monomeric mixture further comprises one or more silicone ophthalmic device-forming silicone comonomers.

In non-limiting illustrative embodiments, as may be combined with one or more of the preceding paragraphs, the surface modified silicone ophthalmic device is a surface modified silicone contact lens.

In non-limiting illustrative embodiments, as may be combined with one or more of the preceding paragraphs, the surface modified silicone ophthalmic device is a surface modified silicone hydrogel.

In non-limiting illustrative embodiments, as may be combined with one or more of the preceding paragraphs, the step of exposing the cationic copolymer to the silicone ophthalmic device comprises extracting the silicone ophthalmic device with an aqueous solution comprising water and the cationic copolymer to form the surface modified silicone ophthalmic device.

In non-limiting illustrative embodiments, as may be combined with one or more of the preceding paragraphs, the method further comprises drying the surface modified silicone ophthalmic device under vacuum at a temperature from about 40° C. to about 110° C. for at least thirty minutes.

In non-limiting illustrative embodiments, as may be combined with one or more of the preceding paragraphs, the step of exposing the cationic copolymer to the silicone ophthalmic device comprises:
immersing the silicone ophthalmic device in an aqueous packaging solution comprising the cationic copolymer, wherein the aqueous packaging solution has an osmolality of at least about 150 mOsm/kg and a pH in the range of about 6 to about 9,
packaging the aqueous packaging solution and the silicone ophthalmic device in a manner preventing contamination of the silicone ophthalmic device by microorganisms, and
sterilizing the packaged solution and the silicone ophthalmic device to form the surface modified silicone ophthalmic device.

According to another aspect of the present disclosure, a packaging system for the storage of a surface modified silicone ophthalmic device comprises a sealed container containing an unused silicone ophthalmic device immersed in an aqueous packaging solution comprising a cationic copolymer comprising (i) monomeric units derived from a cationic monomer having an ethylenically unsaturated reactive end group, and (ii) monomeric units derived from a hydrophilic monomer having an ethylenically unsaturated reactive group, wherein the unused silicone ophthalmic device is a polymerization product of a silicone ophthalmic device-forming monomeric mixture comprising.
(a) one or more hydrophilic monomers,
(b) one or more monofunctional silicone monomers represented by a structure of

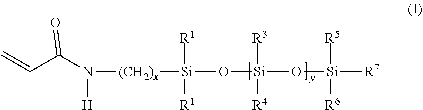

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15,
(c) one or more anionic ophthalmic device forming monomers, and
(d) one or more crosslinking agents, and
wherein the aqueous packaging solution has an osmolality of at least about 150 mOsm/kg, a pH of about 6 to about 9 and is sterilized.

In non-limiting illustrative embodiments, as may be combined with one or more of the preceding paragraphs, the monomeric units derived from the cationic monomer are non-covalently attached to the one or more anionic ophthalmic device forming monomers.

In non-limiting illustrative embodiments, as may be combined with one or more of the preceding paragraphs, the cationic monomer having an ethylenically unsaturated reactive end group is represented by a structure of Formula II:

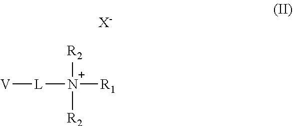

wherein L is a linking group, X⁻ is at least a single charged counter ion, R₁, R₂ and R₃ are each independently hydrogen, or a hydrocarbyl group and V is an ethylenically unsaturated reactive group.

In non-limiting illustrative embodiments, as may be combined with one or more of the preceding paragraphs, L is a divalent hydrocarbon radical, R₁, R₂ and R₃ are each independently, a straight or branched C₁-C₆ alkyl group and V is a (meth)acrylate-containing reactive end group.

In non-limiting illustrative embodiments, as may be combined with one or more of the preceding paragraphs, the cationic monomer having an ethylenically unsaturated reactive end group is a 2-methacryloyloxyethyl-N,N,N-trimethylammonium salt, 2-ethyldimethylammonioethyl methacrylate ethyl sulfate, or diallyldimethylammonium chloride.

In non-limiting illustrative embodiments, as may be combined with one or more of the preceding paragraphs, the hydrophilic monomer having an ethylenically unsaturated reactive group is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the hydrophilic monomer having an ethylenically unsaturated reactive group is one of a vinyl lactam or an acrylamide.

In non-limiting illustrative embodiments, as may be combined with one or more of the preceding paragraphs, the cationic copolymer comprises from about 10 to about 60 monomeric units derived from the cationic monomer having an ethylenically unsaturated reactive end group and from about 40 to about 90 monomeric units derived from the hydrophilic monomer having an ethylenically unsaturated reactive group.

In non-limiting illustrative embodiments, as may be combined with one or more of the preceding paragraphs, the cationic copolymer is a brush cationic copolymer.

In non-limiting illustrative embodiments, as may be combined with one or more of the preceding paragraphs, the cationic copolymer is a random cationic copolymer.

In non-limiting illustrative embodiments, as may be combined with one or more of the preceding paragraphs, the one or more hydrophilic monomers in the silicone ophthalmic device-forming monomeric mixture is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently hydrogen or a C₁ to C₆ alkyl group; R⁵, R⁶ and R⁷ are independently a straight or branched C₁ to C₆ alkyl group; x is from 1 to 6; and y is from 3 to 8.

In non-limiting illustrative embodiments, as may be combined with one or more of the preceding paragraphs, where in the one or more monofunctional silicone monomers in the silicone ophthalmic device-forming monomeric mixture R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 8.

In non-limiting illustrative embodiments, as may be combined with one or more of the preceding paragraphs, the one or more monofunctional silicone monomers includes a first monofunctional silicone monomer represented by Formula I and a second monofunctional silicone monomer represented by Formula I different than the first monofunctional silicone monomer.

In non-limiting illustrative embodiments, as may be combined with one or more of the preceding paragraphs, the one or more anionic ophthalmic device forming monomers include one or more of acrylic acid and methacrylic acid.

In non-limiting illustrative embodiments, as may be combined with one or more of the preceding paragraphs, the silicone ophthalmic device-forming monomeric mixture comprises:
about 5 wt. % to about 60 wt. %, based on the total weight of the silicone ophthalmic device-forming monomeric mixture, of the one or more hydrophilic monomers,
about 10 wt. % to about 55 wt. %, based on the total weight of the silicone ophthalmic device-forming monomeric mixture, of the monofunctional silicone monomer,
about 1 wt. % to about 10 wt. %, based on the total weight of the silicone ophthalmic device-forming monomeric mixture, of the one or more anionic ophthalmic device forming monomers, and
about 0.1 wt. % to about 10 wt. %, based on the total weight of the silicone ophthalmic device-forming monomeric mixture, of the one or more crosslinking agents.

In non-limiting illustrative embodiments, as may be combined with one or more of the preceding paragraphs, the silicone ophthalmic device-forming monomeric mixture further comprises one or more ultraviolet light blockers having an ethylenically unsaturated reactive group.

In non-limiting illustrative embodiments, as may be combined with one or more of the preceding paragraphs, the one or more ultraviolet light blockers having an ethylenically unsaturated reactive group comprise a phenolic group having a hydroxyl moiety and one or more ethylenically unsaturated reactive groups.

In non-limiting illustrative embodiments, as may be combined with one or more of the preceding paragraphs, the one or more ultraviolet light blockers having an ethylenically unsaturated reactive group comprise a benzotriazole compound having a structure of Formula III:

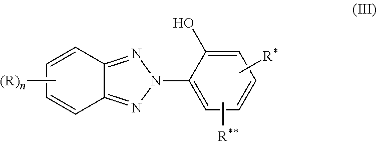

wherein each R is independently hydrogen, a halogen, an —O— group, a nitro group, a nitrile group, a substituted or unsubstituted alkoxy group, a substituted or unsubstituted hydroxyl group, a substituted or unsubstituted amine group, a substituted or unsubstituted carbonyl group, and a substituted or unsubstituted hydrocarbyl group, R* is hydrogen or a substituted or unsubstituted hydrocarbyl group, and R** is an ethylenically unsaturated reactive group.

In non-limiting illustrative embodiments, as may be combined with one or more of the preceding paragraphs, R and R* are each hydrogen and R** is a (meth)acrylate-containing reactive end group.

In non-limiting illustrative embodiments, as may be combined with one or more of the preceding paragraphs, R** is positioned on the aromatic ring in the para position relative to the OH moiety.

In non-limiting illustrative embodiments, as may be combined with one or more of the preceding paragraphs, the one or more ultraviolet light blockers having an ethylenically unsaturated reactive group are present in the silicone ophthalmic device-forming monomeric mixture in an amount of from about 0.4 wt. % to about 4 wt. %, based on the total weight of the silicone ophthalmic device-forming monomeric mixture.

In non-limiting illustrative embodiments, as may be combined with one or more of the preceding paragraphs, the silicone ophthalmic device-forming monomeric mixture further comprises one or more blue light blockers having an ethylenically unsaturated reactive group.

In non-limiting illustrative embodiments, as may be combined with one or more of the preceding paragraphs, the one or more blue light blockers are represented by an acridone compound having a structure of Formula IV:

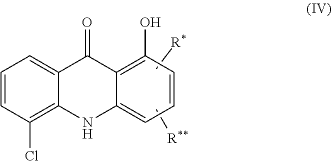

wherein R* is hydrogen or a substituted or unsubstituted hydrocarbyl group, and R** is an ethylenically unsaturated reactive group.

In non-limiting illustrative embodiments, as may be combined with one or more of the preceding paragraphs, the surface modified silicone ophthalmic device demonstrates sufficient blocking of UV light to meet at least FDA Class I specifications for UV blocking.

In non-limiting illustrative embodiments, as may be combined with one or more of the preceding paragraphs, the unused ophthalmic device is an unused silicone contact lens.

In non-limiting illustrative embodiments, as may be combined with one or more of the preceding paragraphs, the unused silicone ophthalmic device is an unused silicone hydrogel.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

1. A surface modified silicone ophthalmic device, comprising:
a silicone ophthalmic device which is a polymerization product of a silicone ophthalmic device-forming monomeric mixture comprising:
(a) one or more hydrophilic monomers;
(b) one or more monofunctional silicone monomers represented by a structure of Formula I: 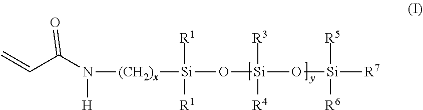
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15;
(c) one or more anionic ophthalmic device forming monomers; and
(d) one or more crosslinking agents; and
a surface coating on the silicone ophthalmic device, the surface coating comprising a cationic copolymer comprising (i) monomeric units derived from a cationic monomer having an ethylenically unsaturated reactive end group, and (ii) monomeric units derived from a hydrophilic monomer having an ethylenically unsaturated reactive group.

2. The surface modified silicone ophthalmic device according to claim 1, wherein the cationic monomer having an ethylenically unsaturated reactive end group is represented by a structure of Formula II: 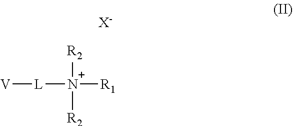
wherein L is a linking group, X⁻ is at least a single charged counter ion, R₁, R₂ and R₃ are each independently hydrogen, or a hydrocarbyl group and V is an ethylenically unsaturated reactive group.

3. The surface modified silicone ophthalmic device according to claim 2, wherein L is a divalent hydrocarbon radical, R₁, R₂ and R₃ are each independently a straight or branched C₁-C₆ alkyl group and V is a (meth)acrylate-containing reactive end group.

4. The surface modified silicone ophthalmic device according to claim 1, wherein the cationic monomer having an ethylenically unsaturated reactive end group is a 2-methacryloyloxyethyl-N,N,N-trimethylammonium salt, 2-ethyldimethylammonioethyl methacrylate ethyl sulfate, or diallyldimethylammonium chloride.

5. The surface modified silicone ophthalmic device according to claim 1, wherein the hydrophilic monomer having an ethylenically unsaturated reactive group is one of a vinyl lactam or an acrylamide.

6. The surface modified silicone ophthalmic device according to claim 1, wherein the cationic copolymer comprises from about 10 to about 60 monomeric units derived from the cationic monomer having an ethylenically unsaturated reactive end group and from about 40 to about 90 monomeric units derived from the hydrophilic monomer having an ethylenically unsaturated reactive group.

7. The surface modified silicone ophthalmic device according to claim 1, wherein the cationic copolymer is a brush cationic copolymer or a random cationic copolymer.

8. The surface modified silicone ophthalmic device according to claim 1, wherein the one or more hydrophilic monomers in the silicone ophthalmic device-forming monomeric mixture is selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

9. The surface modified silicone ophthalmic device according to claim 1, wherein in the one or more monofunctional silicone monomers in the silicone ophthalmic device-forming monomeric mixture R¹, R², R³ and R⁴ are independently hydrogen or a C₁ to C₆ alkyl group; R⁵, R⁶ and R⁷ are independently a straight or branched C₁ to C₆ alkyl group; x is from 1 to 6; and y is from 3 to 8.

10. The surface modified silicone ophthalmic device according to claim 1, wherein in the one or more monofunctional silicone monomers in the silicone ophthalmic device-forming monomeric mixture R¹, R², R³ and R⁴ are independently a C₁ to C₃ alkyl group; R⁵ and R₆ are independently a C₁ to C₃ alkyl group; R⁷ is a straight or branched C₃ to C₆ alkyl group; x is from 2 to 4; and y is from 3 to 8.

11. The surface modified silicone ophthalmic device according to claim 1, wherein the one or more monofunctional silicone monomers includes a first monofunctional silicone monomer represented by Formula I and a second monofunctional silicone monomer represented by Formula I different than the first monofunctional silicone monomer.

12. The surface modified silicone ophthalmic device according to claim 1, wherein the one or more anionic ophthalmic device forming monomers include one or more of acrylic acid and methacrylic acid.

13. The surface modified silicone ophthalmic device according to claim 1, wherein the silicone ophthalmic device-forming monomeric mixture comprises:
about 5 wt. % to about 60 wt. %, based on the total weight of the silicone ophthalmic device-forming monomeric mixture, of the one or more hydrophilic monomers;
about 10 wt. % to about 55 wt. %, based on the total weight of the silicone ophthalmic device-forming monomeric mixture, of the monofunctional silicone monomer;
about 1 wt. % to about 10 wt. %, based on the total weight of the silicone ophthalmic device-forming monomeric mixture, of the one or more anionic ophthalmic device forming monomers; and
about 0.1 wt. % to about 10 wt. %, based on the total weight of the silicone ophthalmic device-forming monomeric mixture, of the one or more crosslinking agents.

14. The surface modified silicone ophthalmic device according to claim 1, wherein the silicone ophthalmic device-forming monomeric mixture further comprises one or more ultraviolet light blockers having an ethylenically unsaturated reactive group, a one or more blue light blockers having an ethylenically unsaturated reactive group or both.

15. The surface modified silicone ophthalmic device according to claim 1, which is a surface modified silicone contact lens.

16. The surface modified silicone ophthalmic device according to claim 1, which is a surface modified silicone hydrogel.

17. A method for making a surface modified silicone ophthalmic device, comprising:
providing a silicone ophthalmic device which is a polymerization product of a silicone ophthalmic device-forming monomeric mixture comprising:
(a) one or more hydrophilic monomers;
(b) one or more monofunctional silicone monomers represented by a structure of Formula I: 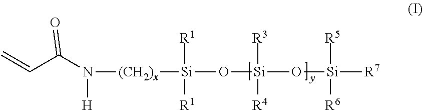
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R¹, R⁶ and R⁷ are independently a straight or branched alkyl group; x is from 1 to 6; and y is from 3 to 15;
(c) one or more anionic ophthalmic device forming monomers; and
(d) one or more crosslinking agents; and
exposing the silicone ophthalmic device to a cationic copolymer comprising (i) monomeric units derived from a cationic monomer having an ethylenically unsaturated reactive end group, and (ii) monomeric units derived from a hydrophilic monomer having an ethylenically unsaturated reactive group, thereby forming a surface coating on the silicone ophthalmic device.

18. The method according to claim 17, wherein the step of exposing the cationic copolymer to the silicone ophthalmic device comprises extracting the silicone ophthalmic device with an aqueous solution comprising water and the cationic copolymer to form the surface modified silicone ophthalmic device.

19. The method according to claim 17, wherein the step of exposing the cationic copolymer to the silicone ophthalmic device comprises:
immersing the silicone ophthalmic device in an aqueous packaging solution comprising the cationic copolymer, wherein the aqueous packaging solution has an osmolality of at least about 150 mOsm/kg and a pH in the range of about 6 to about 9;
packaging the aqueous packaging solution and the silicone ophthalmic device in a manner preventing contamination of the silicone ophthalmic device by microorganisms; and
sterilizing the packaged solution and the silicone ophthalmic device to form the surface modified silicone ophthalmic device.

20. A packaging system for the storage of a surface modified silicone ophthalmic device, comprising:
a sealed container containing an unused silicone ophthalmic device immersed in an aqueous packaging solution comprising a cationic copolymer comprising (i) monomeric units derived from a cationic monomer having an ethylenically unsaturated reactive end group, and (ii) monomeric units derived from a hydrophilic monomer having an ethylenically unsaturated reactive group; wherein the unused silicone ophthalmic device is a polymerization product of a silicone ophthalmic device-forming monomeric mixture comprising:
(a) one or more hydrophilic monomers;
(b) one or more monofunctional silicone monomers represented by a structure of 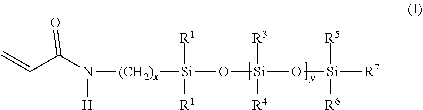
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15;
(c) one or more anionic ophthalmic device forming monomers; and
(d) one or more crosslinking agents; and
wherein the aqueous packaging solution has an osmolality of at least about 150 mOsm/kg, a pH of about 6 to about 9 and is sterilized.
